(19) United States
(12) Patent Application Publication
(10) Pub. No.: US 2025/0174180 A1
(43) Pub. Date: May 29, 2025

(54) TRANSPARENT DISPLAY DEVICE

(71) Applicant: LG Display Co., Ltd., Seoul (KR)

(72) Inventors: Yoonji CHOI, Paju-si (KR); Haksu KIM, Paju-si (KR); HongMan MOON, Paju-si (KR)

(73) Assignee: LG Display Co., Ltd., Seoul (KR)

(21) Appl. No.: 18/950,973

(22) Filed: Nov. 18, 2024

(30) Foreign Application Priority Data
Nov. 29, 2023 (KR) 10-2023-0169375

(51) Int. Cl. G09G 3/32

(52) U.S. Cl. CPC G09G 3/32; G09G 2310/0275; G09G 2310/08; G09G 2320/068

(57) ABSTRACT

In a display device, each sub-pixel may include a first mode sub-pixel with a first viewing angle having a first light emitting element, a second mode sub-pixel with a second viewing angle having a second light emitting element, a driving transistor connected to the first or second light emitting element, mode selection lines providing a first mode selection signal and a second mode selection signal, a first transistor controlling a connection between the first light emitting element and the driving transistor based on the first mode selection signal, and a second transistor controlling a connection between the second light emitting element and the driving transistor based on the second mode selection signal. The first light emitting element is connected to the driving transistor in a first display driving period. The second light emitting element is connected to the driving transistor in a second display driving period.

### CROSS-REFERENCE TO RELATED APPLICATIONS

This application claims the benefit of and priority to Korean Patent Application No. 10-2023-0169375 filed on Nov. 29, 2023, the entire contents of which are incorporated herein by reference for all purposes as if fully set forth herein.

### BACKGROUND

### 1. Technical Field

The present disclosure relates to an electronic device, and particularly to, for example, without limitation, a display device capable of controlling viewing angle.

### 2. Discussion of the Related Art

Recently, there has been a problem of information leakage to third parties through image information displayed on a display device. To solve this problem, security films are being developed to provide image information only to specific people located in front of the display device.

By attaching a security film to the display device, the user can prevent a nearby third party from viewing the image information displayed on the display device, and by removing the security film from the display device, the user can allow a nearby third party to see the image information displayed on the display device. The user has inconvenience of having to carry and manage the security films separately, and it is difficult to partially obscure or provide image information to the third party.

The description of the related art should not be assumed to be prior art merely because it is mentioned in or associated with this section. The description of the related art includes information that describes one or more aspects of the subject technology, and the description in this section does not limit the invention.

### SUMMARY

One or more aspects of the present disclosure are directed to providing a display device capable of controlling a viewing angle without a security film.

Further, one or more aspects of the present disclosure are directed to providing a display device that is capable of controlling a viewing angle partially within a display area.

Further, one or more aspects of the present disclosure are directed to providing a display device capable of implementing Environmental/Social/Governance (ESG) by reducing the generation of greenhouse gases that can be generated by a manufacturing process.

The problems to be solved by the examples of the present disclosure are not limited to those mentioned above, and other problems not mentioned will be apparent to one of ordinary skill in the art to which the technical spirits of the present disclosure belong from the following description.

A display device according to an example embodiment of the present disclosure includes a display panel provided with a plurality of sub-pixels displaying images in display driving period, wherein each of the plurality of sub-pixels comprises, a first mode sub-pixel having a first viewing angle and comprising a first light emitting element, a second mode sub-pixel having a second viewing angle and comprising a second light emitting element, a driving transistor connected to the first light emitting element or the second light emitting element, a first mode selection line extending in a first direction and providing a first mode selection signal, a second mode selection line extending in the first direction and providing a second mode selection signal, a first control transistor controlling a connection between the first light emitting element and the driving transistor based on the first mode selection signal, and a second control transistor controlling a connection between the second light emitting element and the driving transistor based on the second mode selection signal, wherein the display driving period is time-divided into a first display driving period and a second display driving period, and wherein the first light emitting element is connected to the driving transistor in the first display driving period and the second light emitting element is connected to the driving transistor in the second display driving period.

A display device according to another example embodiment of the present disclosure includes a display panel provided with a plurality of sub-pixels comprising a first mode sub-pixel and a second mode sub-pixel in a display area and a timing controller outputting a first pixel data for the first mode sub-pixel and a second pixel data for the second mode sub-pixel to the display panel, wherein the display panel supplies the first pixel data to the first mode sub-pixel in a first display driving period and the second pixel data to the second mode sub-pixel in a second display driving period, and wherein the first display driving period and the second display driving period are temporally separated.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a perspective view illustrating a display device according to one example embodiment of the present disclosure.

FIG. 2 is a block diagram schematically illustrating a configuration of a display device, according to one example embodiment of the present disclosure.

FIG. 3 is a plan view illustrating an example of a pixel in a display device according to one example embodiment of the present disclosure.

FIG. 4 is a cross-sectional view illustrating an example of a first mode sub-pixel according to I-I′ illustrated in FIG. 3.

FIG. 5 is a cross-sectional view illustrating an example of a second mode sub-pixel according to II-II′ illustrated in FIG. 3.

FIG. 6 is an equivalent circuit diagram illustrating a circuit configuration of each sub-pixel in a display panel, according to one embodiment.

FIG. 7 is a plan view illustrating an example of a set of scan lines and mode selection lines disposed on a display panel, according to one example embodiment of the present disclosure.

FIG. 8 is a diagram illustrating one example of a driving waveform for sub-pixels disposed on a display panel, according to one example embodiment of the present disclosure.

FIG. 9 is a diagram illustrating another example of a driving waveform for sub-pixels disposed on a display panel, according to one example embodiment of the present disclosure.

FIG. 10 is a diagram illustrating various examples in which one frame is time-dived into a first display driving period and a second display driving period to be driven when an image data is input in frame units.

FIG. 11 is a plan view illustrating an example of mode selection lines and data lines disposed on a display panel, according to one example embodiment of the present disclosure.

FIG. 12A is a diagram illustrating one example of a first mode display area and a second mode display area.

FIG. 12B is a diagram illustrating one example of first pixel data input in a first display driving period.

FIG. 12C is a diagram illustrating an example of second pixel data input in the second display driving period.

FIG. 13A is a diagram illustrating another example of a first mode display area and a second mode display area.

FIG. 13B is a diagram illustrating another example of first pixel data being input in the first display driving period.

FIG. 13C is a diagram illustrating another example of second pixel data being input in the second display driving period.

FIG. 14A is a diagram illustrating another example of a first mode display area and a second mode display area.

FIG. 14B is a diagram illustrating one example of a driving waveform for the sub-pixels illustrated in FIG. 14A.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure. Further, the present disclosure is defined by the scope of claims and their equivalents.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “on a top of,” “upon,” “on top of,” “over,” “under,” “above,” “upper,” “at an upper portion,” “at a upper side,” “below,” “lower,” “at a lower portion,” “at a lower side,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “covers,” “surrounds,” “is in contact,” “overlaps,” “crosses,” “intersects,” “is connected,” “is coupled,” “is attached,” “is adhered,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The phrase “through” may be understood, for example, to be at least partially through or entirely through.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally. For example, the terms “first direction,” “second direction,” and the like should not be interpreted only based on a geometrical relationship in which the respective directions are parallel, perpendicular, diagonal, or slanted with respect to each other, and may be meant as directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein. For example, the term “part” or “unit” may apply, for example, to a separate circuit, component or structure, an integrated circuit, a computational block of a circuit device, or a structure configured to perform a described function as should be understood by one of ordinary skill in the art.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

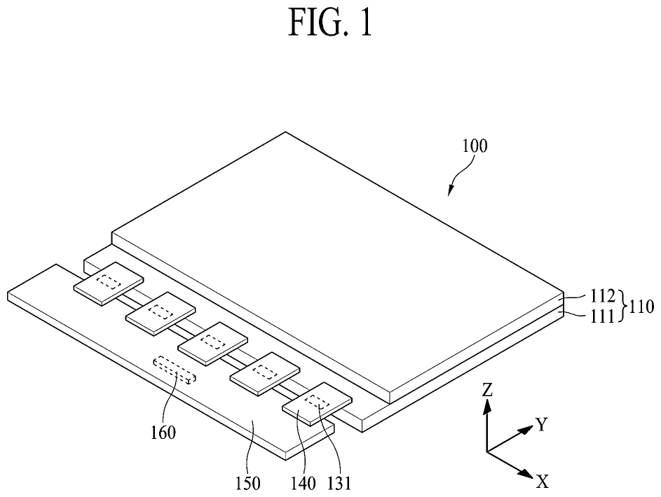

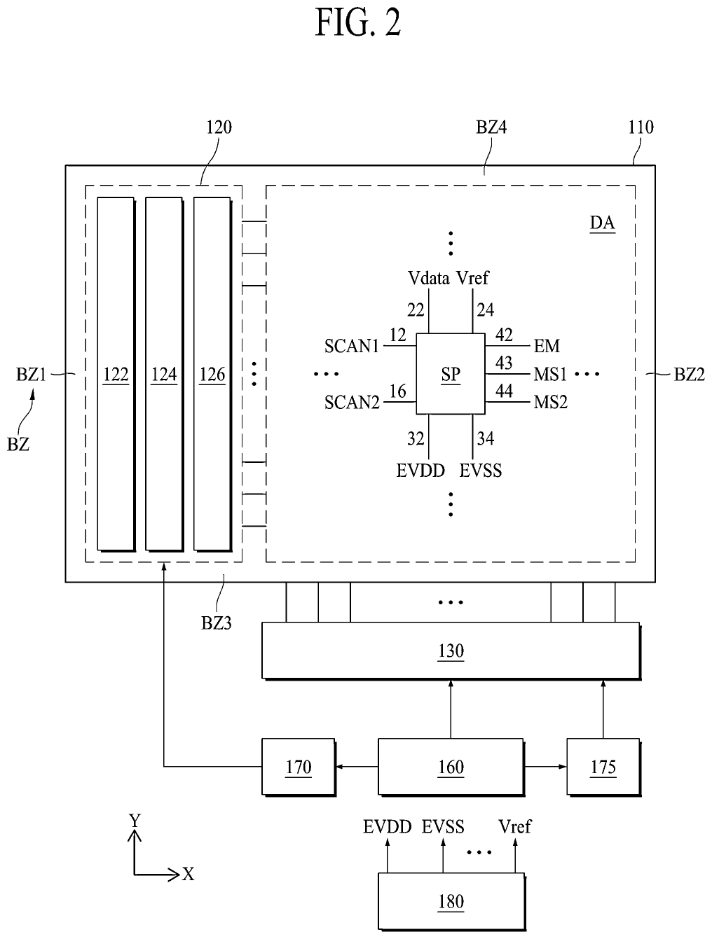

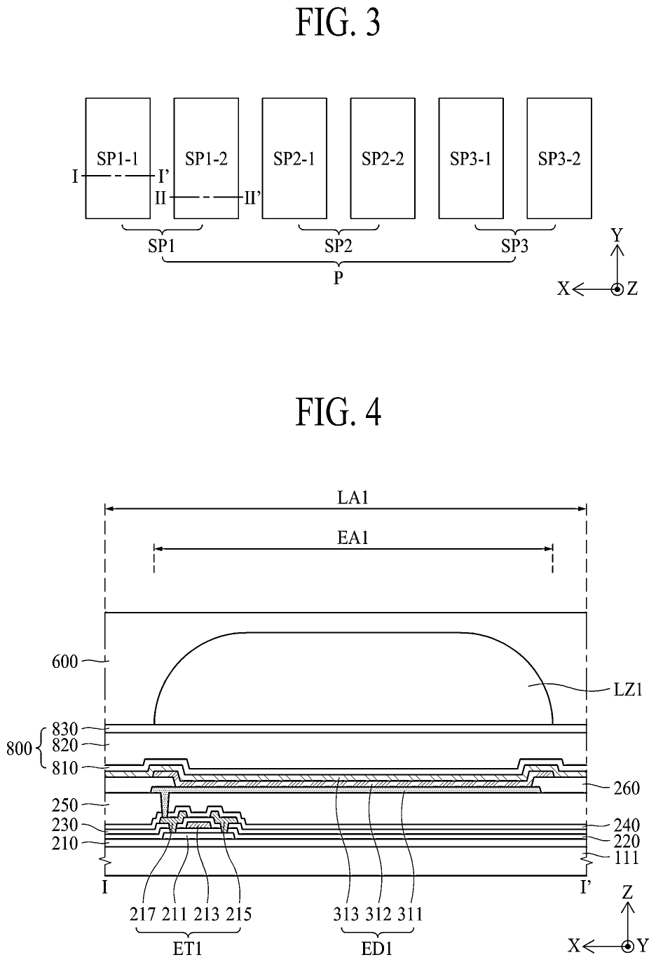

FIG. 1 is a perspective view illustrating a display device according to one example embodiment of the present disclosure and FIG. 2 is a block diagram schematically illustrating a configuration of a display device, according to one example embodiment of the present disclosure. FIG. 3 is a plan view illustrating an example of a pixel in a display device according to one example embodiment of the present disclosure.

While the display device 100 according to one example embodiment of the present disclosure has been described with emphasis on its implementation as an Organic Light Emitting Display, it can also be implemented as a Liquid Crystal Display, Quantum dot Lighting Emitting Diode, or Electrophoresis display.

Referring to FIGS. 1 and 2, the display device 100 according to one example embodiment of the present disclosure includes a display panel 110, a gate driver 120 embedded in the display panel 110, a data driver 130 connected to the display panel 110, a timing controller 160 controlling the gate driver 120 and the data driver 130, a gamma voltage generator 175, and a power circuit 180. In one embodiment, the display device 100 can further include a level shifter 170 connected between the timing controller 160 and the gate driver 120. In one embodiment, the data driver 130, the timing controller 160, the gamma voltage generator 175, and the level shifter 170 can be integrated into a display driver.

The display panel 110 includes a first substrate 111 and a second substrate 112. The second substrate 112 can be an encapsulation substrate. The first substrate 111 can be a plastic film or a glass substrate, but is not necessarily limited to. The first substrate 111 can also be made of a semiconductor material, such as a silicon wafer. The second substrate 112 can be a plastic film, a glass substrate, or an encapsulation film (or protective film).

The display device 100 according to one example embodiment of the present disclosure can emit light in a so-called top emission type in which the emitted light is emitted upwardly but is not necessarily limited thereto. When the display device 100 emits light in a top emission type, the material of the first substrate 111 can include an opaque material as well as a transparent material. When the display device 100 emits light in a bottom emission type in which the emitted light is emitted downwardly, the material of the first substrate 111 can include a transparent material. Hereinafter, for convenience of explanation, it is assumed that the display device 100 emits light in the top emission type, but is not necessarily limited thereto.

The display panel 110 includes a display area DA and a bezel area BZ. The bezel area BZ is surrounding the display area DA and disposed at a periphery. The display panel 110 displays images in the display area DA with a plurality of sub-pixels SP disposed in a matrix type. The plurality of sub-pixels SPs can include a plurality of row lines including sub-pixels SPs disposed in a first direction (e.g., X-axis direction) and a plurality of column lines including sub-pixels SPs disposed in a second direction (e.g., Y-axis direction).

As shown in FIG. 3, each of the sub-pixels SPs can be one of a first sub-pixel SP1 emitting red light, a second sub-pixel SP2 emitting green light, and a third sub-pixel SP3 emitting blue light, but not necessarily limited to. An unit pixel P can include at least two or more sub-pixels SPs. In one example, as shown in FIG. 3, the unit pixel P can include the first sub-pixel SP1, the second sub-pixel SP2, and the third sub-pixel SP3. The unit pixel P can further include a fourth sub-pixel that emits white light. Further, the arrangement order of the sub-pixels SP1, SP2, and SP3 can be varied.

On the other hand, each of the sub-pixels SP1, SP2, and SP3 can include two or more mode sub-pixels having different viewing angles. For example, as shown in FIG. 3, each of the sub-pixels SP1, SP2, and SP3 can include a first mode sub-pixel SP1-1, SP2-1, and SP3-1 and a second mode sub-pixel SP1-2, SP2-2, and SP3-2. The first mode sub-pixels SP1-1, SP2-1, and SP3-1 can have a first viewing angle and include a first emitting element and the second mode sub-pixels SP1-2, SP2-2, and SP3-2 can have a second viewing angle and include a second emitting element. The first viewing angle and the second viewing angle can differ in at least one of a direction and an angular range. In one example, the second viewing angle can have a smaller angular range than the first viewing angle. As another example, the first viewing angle can be 30 degrees to the left from a frontal 0 degree, and the second viewing angle can be 30 degrees to the right from the frontal 0 degree.

Each sub-pixel SP1, SP2, and SP3 can selectively drive one of the first emitting element and the second emitting element to control a viewing angle. In one example, each sub-pixel SP1, SP2, and SP3 can implement a first viewing angle mode by driving the first emitting element of the first mode sub-pixel SP1-1, SP2-1, and SP3-1. In one embodiment, the first viewing angle mode can be a wide viewing angle mode or a share mode. In another example, each sub-pixel SP1, SP2, and SP3 can implement a second viewing angle mode by driving the second emitting element of a second mode sub-pixel SP1-2, SP2-2, and SP3-2. In one embodiment, the second viewing angle mode can be a narrow viewing angle mode or a privacy mode, the narrow viewing angle mode or the privacy mode can limit the angular range of the viewing angle to a smaller extent than the first viewing angle mode.

The display panel 110 can include a plurality of signal lines including data lines 22, gate lines 12, 16, 42, and 44, and power lines 24, 32, and 34 connected to each of the sub-pixels SPs.

The data lines 22 can be disposed to extend in the second direction (e.g., in the Y-axis direction) to supply each sub-pixel SP with a data voltage Vdata supplied from the data driver 130.

The gate lines 12, 16, 42, 43, and 44 can be disposed to intersect with the data lines 22 to supply signals supplied from the gate driver 120 to each sub-pixel SP. Specifically, some of the gate lines 12, 16, 42, 43, and 44 (12, 16, referred to herein as “scan lines”) can supply scan signals SCAN1 and SCAN2 supplied from the scan driver 122 to each sub-pixel SP. Another portion of the gate lines 12, 16, 42, 43, and 44 (42, hereinafter referred to as “emitting control lines”) can supply emitting signals EM supplied from the emitting control driver 124 to each sub-pixel SP.

The other portion of the gate lines 12, 16, 42, 43, 44 (43, 44, hereinafter referred to as “mode selection lines”) can supply mode selection signals MS1 and MS2 supplied from the mode selection driver 126 to each sub-pixel SP. The first mode selection line 43 between the mode selection lines 43 and 44 can supply a first mode selection signal MS1 to each sub-pixel SP for driving the first emitting element of the first mode sub-pixel SP1-1, SP2-1, and SP3-1. The second mode selection line 44 between the mode selection lines 43 and 44 can supply a second mode selection signal MS2 to each sub-pixel SP for driving the second emitting element of the second mode sub-pixel SP1-2, SP2-2, and SP3-2.

In this example, the display device 100 can control the viewing angle of each sub-pixel SP by selectively driving the first emitting element and the second emitting element of each sub-pixel SP using the first and second mode selection signals MS1 and MS2. A detailed description of this will be described later.

The initialization voltage line 24 among the power lines 24, 32, and 34 can supply an initialization voltage Vref supplied from the power circuit 180 to each sub-pixel SP. A first power line 32 can supply a first power voltage (or high potential power voltage) EVDD to each sub-pixel SP. The second power line 34 can supply a second power voltage (or low potential power voltage) EVSS to each sub-pixel SP through a common electrode (or cathode electrode).

The gate driver 120 can be disposed in at least one of the plurality of bezel areas BZ1 to BZ2 disposed in the periphery of the display area DA. For example, the gate driver 120 can be disposed in any one of the first and second bezel areas BZ1 and BZ2 facing each other with the display area DA interposed therebetween, or can be disposed on both sides of the first and second bezel areas BZ1 and BZ2. The gate driver 120 can be disposed in a Gate In Panel GIP type, which is composed of transistors formed in the same process as the transistors disposed in the display area DA.

The gate driver 120 can include the scan driver 122 driving a plurality of gate lines 12 and 16 connected to the sub-pixels SPs of each row line, an emitting control driver 124 driving an emitting control line 42 connected to the sub-pixels SPs of each row line, and a mode selection driver 126 driving a plurality of mode selection lines 43 and 44 connected to the sub-pixels SPs of each row line.

Each of the scan driver 122, the emitting control driver 124, and the mode selection driver 126 can receive a plurality of control signals that are supplied through the level shifter 170 from the timing controller 160 to operate. In one embodiment, each of the scan driver 122, the emitting control driver 124, and the mode selection driver 126 can receive the plurality of control signals from the timing controller 160.

The level shifter 170 can receive control signals from the timing controller 160. By shifting level of the control signals or performing a logic process to the control signals a plurality of gate control signals GCS, a plurality of emitting control signals ECS, and a plurality of mode control signals MCS can be generated to be supplied to the scan driver 122, the emitting control driver 124, and the mode selection driver 126, respectively.

The scan driver 122 can supply at least one scan signal SCAN1 and SCAN2 to each of the plurality of row lines using the gate control signal GCS supplied from the level shifter 170 or the timing controller 160. The scan driver 122 can supply the scan signals SCAN1 and SCAN2 to the plurality of scan lines 12 and 16 connected to the sub-pixels SP of each row line.

The emitting control driver 124 can supply an emitting signal EM to each of the plurality of row lines using the emitting control signal ECS supplied from the level shifter 170 or the timing controller 160. The emitting control driver 124 can supply the emitting signal EM to the emitting control line 42 connected to the sub-pixels SP of each of the row lines.

The mode selection driver 126 can supply the mode selection signals MS1 and MS2 to each of the plurality of row lines using the mode control signals MCS supplied from the level shifter 170 or the timing controller 160. The mode select driver 126 can supply the mode selection signals MS1 and MS2 to the mode selection lines 43 and 44 connected to the sub-pixels SP of each of the row lines.

The gamma voltage generator 175 can generate a plurality of reference gamma voltages having different voltage levels and supply them to the data driver 130. The gamma voltage generator 175 can generate and supply the plurality of reference gamma voltages corresponding to a gamma characteristic of the display device to the data driver 130 under control of the timing controller 160. In one embodiment, the gamma voltage generator 175 can adjust the levels of the reference gamma voltages according to a gamma data supplied from the timing controller 160 and output them to the data driver 130.

The data driver 130 receives pixel data DATA and a data control signal DCS from the timing controller 160. The data driver 130 converts the pixel data DATA to analog positive/negative data voltages Vdata using the data control signals DCS and supplies them through the data lines 22 to the sub-pixels SP.

As shown in FIG. 1, the data driver 130 can include a plurality of data drive ICs 131. Each of the plurality of data drive ICs 131 can be mounted on a circuit film 140 in a chip on film COF type, chip on plastic COP type, flexible printed circuit FPC type, or flexible flat cable FFC type. The circuit film 140 is attached to pads disposed in a non-display area NDA of the display panel 110 using an anisotropic conducting film, such that the plurality of data drive ICs 131 can be connected to the pads.

The circuit board 150 can be attached to the circuit film 140. A plurality of circuits implemented as driving chips can be mounted on the circuit board 150. For example, the timing controller 160 can be mounted on the circuit board 150. The circuit board 150 can be a printed circuit board or a flexible printed circuit board.

The timing controller 160 receives digital video data and timing signals from the host system. The timing signals can include a vertical synchronization signal, a horizontal synchronization signal, a data enable signal, a dot clock, and the like. The vertical synchronization signal is a signal that defines the duration of one frame. A horizontal synchronization signal is a signal that defines a period of one horizontal period required to supply data voltages to the pixels of one horizontal line of the display panel DIS. The Data Enable signal defines the period in which valid data is input. The dot clock is a signal that repeats at a predetermined short interval.

Based on the timing signals, the timing controller 160 can generate the data control signal DCS to control the timing of operation of the data driver 130, the gate control signal GCS to control the timing of operation of the scan driver 122, the emitting control signal ECS to control the timing of operation of the emitting control driver 124, and the mode control signal MCS to control the timing of operation of the mode selection driver 126. The timing controller 160 can supply the gate control signal GCS to the scan driver 122, the emitting control signal ECS to the emitting control driver 124, and the mode control signal MCS to the mode selection driver 126. In addition, the timing controller 160 can supply the data control signal DCS to the data driver 130. The timing controller 160, according to one embodiment, can generate and supply control signals for timing control to the level shifter 170 such that the level shifter 170 can generate and supply a plurality of control signals GCS, ECS, and MCS to the scan driver 122, the emitting control driver 124, and the mode selection driver 126.

Further, the timing controller 160 can convert the digital video data into pixel data DATA by aligning the digital video data to match the pixel structure formed on the display panel 110. The pixel data DATA can include first pixel data for the first mode sub-pixels SP1-1, SP2-1, and SP3-1 and second pixel data for the second mode sub-pixels SP1-2, SP2-2, and SP3-2.

The digital video data input from the host system can include information about an image to be displayed in the display area DA. The image can include a first image displayed through the first mode sub-pixels SP1-1, SP2-1, and SP3-1 and a second image displayed through the second mode sub-pixels SP1-2, SP2-2, and SP3-2. The first image and the second image can be implemented as separate digital video data, or the first image and the second image can be integrated to be implemented as single digital video data.

In one example, the digital video data can include first digital video data comprising information about a first image and second digital video data comprising information about a second image. In this example, the first digital video data and the second digital video data can be input from the host system to the timing controller 160. The timing controller 160 can align the first digital video data to convert it to first pixel data DATA1, and can align the second digital video data to convert it to second pixel data DATA2. The timing controller 160 can supply the first pixel data DATA1 and the second pixel data DATA2 along with a data control signal DCS to the data driver 130.

In another example, the digital video data can include the single digital video data that the first image and the second image are integrated. In this example, the timing controller 160 can receive position information of an area in which the first image or the second image is displayed along with the integrated single digital video data from the host system. The timing controller 160 can convert the digital video data into first pixel data DATA1 and the second pixel data DATA2 using the position information of the area in which the first image or the second image is displayed. The timing controller 160 can supply the first pixel data DATA1 and the second pixel data DATA2 along with the data control signal DCS to the data driver 130.

The power circuit 180 can generate and supply a plurality of drive voltages required for operation of all circuit configurations of the display device 100 using the input voltage. The power circuit 180 can generate and supply the first power voltage EVDD, the second power voltage EVSS, and the initialization voltage Vref (or a reference voltage) to the display panel 110. The power circuit 180 can generate and supply various drive voltages required for operation of the gate driver 120, the data driver 130, the timing controller 160, the level shifter 170, and the gamma voltage generator 175.

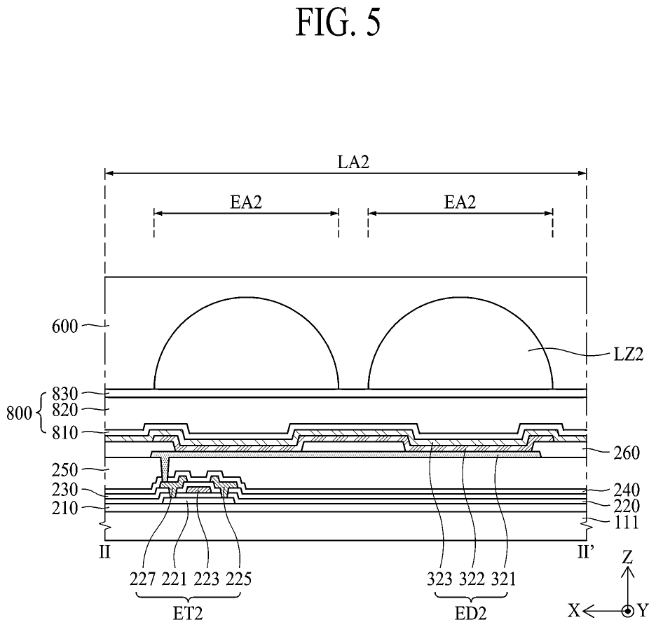

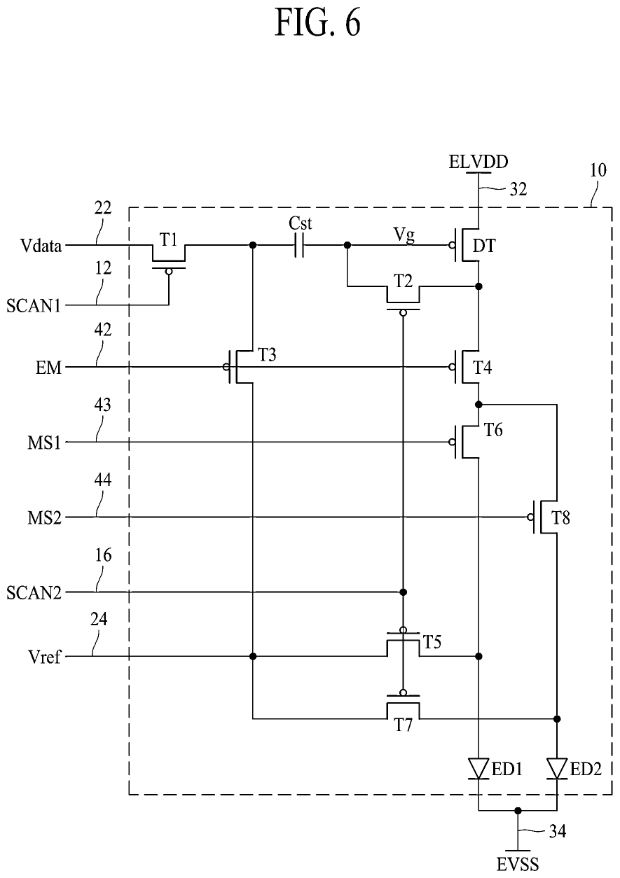

FIG. 4 is a cross-sectional view illustrating an example of a first mode sub-pixel according to I-I′ shown in FIG. 3, and FIG. 5 is a cross-sectional view illustrating an example of a second mode sub-pixel according to II-II′ shown in FIG. 3.

Each of the sub-pixels SP1, SP2, and SP3 disposed in the display panel 110 according to an example embodiment of the present disclosure can include the first mode sub-pixels SP1-1, SP2-1, and SP3-1 and the second mode sub-pixels SP1-2, SP2-2, and SP3-2 having different viewing angles. There are various ways to implement different viewing angles of the first mode sub-pixels SP1-1, SP2-1, and SP3-1 and the second mode sub-pixels SP1-2, SP2-2, and SP3-2. In one example, as shown in FIGS. 4 and 5, the first mode sub-pixels SP1-1, SP2-1, and SP3-1 and the second mode sub-pixels SP1-2, SP2-2, and SP3-2 with different viewing angles can be implemented using the lenses LZ1 and LZ2.

As shown in FIGS. 4 and 5, a display panel 110 according to one embodiment includes the first substrate 111, a circuit element layer including transistors ET1 and ET2 disposed on the first substrate 111, an emitting element layer including emitting elements ED1 and ED2 disposed on the circuit element layer, an encapsulation layer 800 disposed on the emitting element layer, and a lens layer including lenses LZ1 and LZ2 disposed on the encapsulation layer 800. The display panel 110 according to one embodiment can further include a touch sensor layer disposed between the encapsulation layer 800 and the lens layer. The display panel 110 according to one embodiment can further include a color filter layer comprising a color filter and a black matrix disposed between the touch sensor layer and the lens layer.

Each sub-pixel SP1, SP2, and SP3 can include a first lens area LA1 shown in FIG. 4, and a second lens area LA2 shown in FIG. 5.

Referring to FIG. 4, the first lens area LA1 can include a first control transistor ET1 of the pixel circuit, a first emitting element ED1 connected to the first control transistor ET1, and a first lens LZ1 disposed to overlap a first light emitting area EA1 on the first emitting element ED1.

Referring to FIG. 5, the second lens area LA2 can include a second control transistor ET2 of the pixel circuit, a second emitting element ED2 connected to the second control transistor ET2, and a plurality of second lenses LZ2 disposed to overlap a plurality of second light emitting areas EA2 on the second emitting element ED2, respectively.

In the display panel 110 according to one embodiment, the circuit element layer disposed on the first substrate 111 can include a plurality of insulating layers stacked on the first substrate 111. For example, the plurality of insulating layers can include a buffer layer 210, a gate insulating layer 220, an interlayer insulating layer 230, a protection layer 240, and a planarization layer 250.

The first substrate 111 can include an insulating material, such as glass or plastic. The plastic substrate can be formed of a flexible material. For example, the first substrate 111 can include an organic insulating material of at least one of an acrylic-based resin, an epoxy-based resin, a siloxane-based resin, a polyimide-based resin, and a polyamide-based resin.

The buffer layer 210 can have a single-layer or multi-layer structure comprising an inorganic insulating material such as silicon oxide SiOx, silicon nitride SiNx, or aluminum oxide Al₂O₃. The buffer layer 210 can prevent hydrogen from flowing into the semiconductor layers 211 and 221 through the first substrate 111.

The control transistors ET1 and ET2 can be disposed on the buffer layer 210.

The first control transistor ET1 includes a semiconductor layer 211, a gate electrode 213, a source electrode 215, and a drain electrode 217 disposed on the buffer layer 210. The second control transistor ET2 includes a semiconductor layer 221, a gate electrode 223, a source electrode 225, and a drain electrode 227 disposed on the buffer layer 210. A gate insulating layer 220 can be disposed between the semiconductor layers 211 and 221 and the gate electrodes 213 and 223. An interlayer insulating layer 230 can be disposed between the gate electrodes 213 and 223 and the source and drain electrodes 215, 217, 225, and 227. Each of the source electrode 215 and the drain electrode 217 of the first control transistor ET1 can be connected to a source area and a drain area of the semiconductor layer 211, respectively, through each contact holes penetrating the interlayer insulating layer 230 and the gate insulating layer 220. Each of the source electrode 225 and the drain electrode 227 of the second control transistor ET2 can be connected to a source area and a drain area of the semiconductor layer 221, respectively, through each contact holes penetrating the interlayer insulating layer 230 and the gate insulating layer 220.

The semiconductor layers 211 and 221 can include polycrystalline silicon, or can comprise an oxide semiconductor material. The semiconductor layers 211 and 221 can include low temperature polysilicon LPTS. The semiconductor layers 211 and 221 can include an oxide semiconductor material of at least one of IZO series (InZnO), IGO series (InGaO), ITO series (InSnO), IGZO series (InGaZnO), IGZTO series (InGaZnSnO), GZTO series (GaZnSnO), GZO series (GaZnO), and ITZO series (InSnZnO). A light blocking layer can further be disposed below the semiconductor layers 211 and 221.

The gate insulating layer 220 can include an inorganic insulating material such as silicon oxide SiOx and silicon nitride SiNx. The gate insulating layer 220 can include a material having a high dielectric constant. For example, the gate insulating layer 220 can include a high-K material such as hafnium oxide HfO. The gate insulating layer 220 can have a multi-layer structure.

The gate lines connected to the gate electrodes 213 and 223 can be disposed on the gate insulating layer 220.

The interlayer insulating layer 230 can include an inorganic insulating material such as silicon oxide SiOx and silicon nitride SiNx. The interlayer insulating layer 230 can have a multi-layer structure.

Data lines and power lines connected to the source electrodes 215 and 225 or the drain electrodes 217 and 227 can be disposed on the interlayer insulating layer 230.

A protection layer 240 and a planarization layer 250 can be stacked on the first and second control transistors ET1 and ET2. The protection layer 240 can include an inorganic insulating material such as silicon oxide SiOx and silicon nitride SiNx. The planarization layer 250 can include an organic insulating material different from the protection layer 240 and provide a planar surface.

The emitting element layer including the first emitting element ED1 and the second emitting element ED2 can be disposed on the planarization layer 250.

The first emitting element ED1 includes a first electrode 311 disposed on the planarization layer 250, a light emitting layer 312 disposed on the first electrode 311, and a second electrode 313 disposed on the light emitting layer 312. The second emitting element ED2 includes a first electrode 321 disposed on the planarization layer 250, a light emitting layer 322 disposed on the first electrode 321, and a second electrode 323 disposed on the light emitting layer 322. The first emitting element ED1 and the second emitting element ED2 disposed in each sub-pixel SP1, SP2, and SP3 can emit light of the same color.

The first electrode 311 of the first emitting element ED1 can be connected to any one of the source electrode 215 and the drain electrode 217 of the first control transistor ET1 through the contact hole penetrating the protection layer 240 and the planarization layer 250. The first electrode 321 of the second emitting element ED2 can be connected to any one of the source electrode 225 and the drain electrode 227 of the second control transistor ET2 through the contact hole penetrating the protection layer 240 and the planarization layer 250.

The first electrodes 311 and 321 can include a conductive material having a high reflectivity. The first electrodes 311 and 321 can include metals such as aluminum Al, silver Ag, titanium Ti, and silver-palladium-copper APC alloys. The first electrodes 311 and 321 can further comprise a transparent conductive material such as indium tin oxide ITO or indium zinc oxide IZO. For example, the first electrodes 311 and 321 can have a multilayer structure (Ti/Al/Ti) of titanium Ti and aluminum Al, a multilayer structure (ITO/Al/ITO) of a multilayer structure of ITO and aluminum Al, or a multilayer structure (ITO/APC/ITO) of ITO and APC.

The light emitting layers 312 and 322 can include an emission material layer EML including an emissive material. The emission material can include an organic material, an inorganic material, or a hybrid material. The light emitting layer 312 of the first emitting element ED1 and the light emitting layer 322 of the second emitting element ED2 can be spaced apart from each other. Accordingly, light emission by a leakage current can be prevented.

The light emitting layers 312 and 322 can have a multi-layer structure. For example, the light emitting layers 312 and 322 can further include at least one of a hole injection layer HIL, a hole transport layer HTL, an electron transport layer ETL, and an electron injection layer EIL.

The second electrodes 313 and 323 can include a conductive material that transmits light. The second electrodes 313 and 323 can include a transparent conductive material such as ITO or IZO. The second electrodes 313 and 323 can include aluminum Al, magnesium Mg, silver Ag, or an alloy thereof, and can have a thin thickness that can transmit light. Accordingly, light generated by each of the light emitting layers 312 and 322 can be emitted through each of the second electrodes 313 and 323.

The first electrode 311 of the first emitting element ED1 can be spaced apart from the first electrode 321 of the second emitting element ED2, and a bank 260 can be disposed between the first electrodes 311 and 321. The bank 260 can cover an edge of each of the first electrodes 311 and 321. The bank 260 can include an organic insulating material. The bank 260 can include an organic material different from the planarization layer 250, and can have a single-layer structure or a double-layer structure.

The bank 260 can define a first emission area EA1 by having an opening through which the first electrode 311 is exposed. The light emitting layer 312 and the second electrode 313 of the first emitting element ED1 can be stacked on the first electrode 311 exposed by the opening of the bank 260.

The bank 260 can define a second emission area EA2 by having an opening through which the first electrode 321 of the second emitting element ED2 is exposed. In one embodiment, the bank 260 can define a plurality of second emission areas EA2 by having a plurality of openings on the first electrode 321 of the second emitting element ED2. The light emitting layer 322 and the second electrode 323 of the second emitting element ED2 can be stacked on the first electrode 321 exposed by the openings of the bank 260. The emitting layer 322 and second electrode 323 of the second emitting element ED2 can overlap the first electrode 321 with the bank 260 interposed therebetween. In the second lens area LA2, the plurality of second emitting areas EA2 can be spaced apart by the bank 260 and disposed independently, but can share the first electrode 321, the light emitting layer 322, and the second electrode 323 of the second emitting element ED2. Accordingly, the light emission efficiency of the second light emitting area EA2 can be improved. The size of the second light emitting area EA2 can be smaller than the size of the first light emitting area EA1.

The second electrode 313 of the first emitting element ED1 can be a common electrode electrically connected with the second electrode 323 of the second emitting element ED2.

The encapsulation layer 800 can be disposed on the emitting element layer including the first emitting element ED1 and the second emitting element ED2. The encapsulation layer 800 can prevent damage to the emitting elements ED1 and ED2 by moisture and impact from the outside. The encapsulation layer 800 can have a multi-layer structure. For example, the encapsulation layer 800 can include, but is not limited to, a first encapsulation layer 810, a second encapsulation layer 820, and a third encapsulation layer 830 stacked in sequence. The first encapsulation layer 810, the second encapsulation layer 820, and the third encapsulation layer 830 can include an insulating material. The second encapsulation layer 820 can include a material different from the first encapsulation layer 810 and the third encapsulation layer 830. For example, the first encapsulation layer 810 and the third encapsulation layer 830 can be inorganic encapsulation layers including an inorganic insulating material, and the second encapsulation layer 820 can be an organic encapsulation layer including an organic insulating material. Accordingly, the emitting elements ED1 and ED2 can be more effectively prevented from being damaged by moisture and impact from the outside.

The lens layer including a first lens LZ1 and a second lens LZ2 can be disposed on the encapsulation layer 800.

The first lens LZ1 can be disposed on the first emitting element ED1 of the first mode sub-pixel SP1-1, SP2-1, and SP3-1, and can be disposed on the light propagation path of the first emitting element ED1. The second lens LZ2 can be disposed on the second emitting element ED2 of the second mode sub-pixel SP1-2, SP2-2, and SP3-2, and can be disposed on the light propagation path of the second emitting element ED2.

In each of the sub-pixels SP1, SP2, and SP3, the second emitting element ED2 can include a plurality of second emitting elements ED2 or the plurality of second emitting areas, and the plurality of second lenses LZ2 can be individually disposed on the plurality of second emitting elements ED2 or the plurality of second emitting areas EA2. In each of the sub-pixels SP1, SP2, and SP3, the plurality of second emitting elements ED2 or the plurality of second emitting areas EA2 can be connected in parallel.

The first lens LZ1 and the second lens LZ2 can differently control (limit) a viewing angle in at least one direction. In one example, the first lens LZ1 and the second lens LZ2 can control (limit) the viewing angle in the first direction (e.g., the X-axis direction) differently and control (limit) the viewing angle in the second direction (e.g., the Y-axis direction) identically.

For example, the first lens LZ1 does not limit the propagation path of light emitted from the first emitting element ED1 to within a certain angle in the first direction (e.g., the X-axis direction), and thus the viewing angle can be controlled to be a wide field of view. The second lens LZ2 limits the propagation path of the light emitted from the second emitting element ED2 to within a certain angle in the first direction (e.g., the X-axis direction), and thus the viewing angle can be controlled to be a narrow field of view.

When the first emitting element ED1 is driven in each of the sub-pixels SP1, SP2, and SP3, the corresponding sub-pixel can operate in a wide viewing angle mode that does not limit the viewing angle in the first direction (e.g., the X-axis direction). When the second emitting element ED2 is driven in each of the sub-pixels SP1, SP2, and SP3, the corresponding sub-pixel can operate in a narrow viewing angle mode that limits the viewing angle in the first direction (e.g., the X-axis direction).

That is, each sub-pixel SP1, SP2, and SP3 can drive a first emitting element ED1 to implement the first viewing angle mode, the wide viewing angle mode, or a share mode through the first lens area LA1. Each of the sub-pixels SP1, SP2, and SP3 can drive the second emitting element ED2 to implement the second viewing angle mode, the narrow viewing angle mode, or the privacy mode that limit a viewing angle smaller than the wide viewing angle mode through the second lens area LA2.

A lens protection layer 600 can be disposed on the first lens LZ1 and the second lens LZ2 of each sub-pixel SP1, SP2, and SP3. The lens protection layer 600 can include an organic insulating material. The refractive index of the lens protection layer 600 can be smaller than the refractive index of the first lens LZ1 and the refractive index of the second lens LZ2. Accordingly, light passing through the first lens LZ1 and the second lens LZ2 cannot be reflected in the direction of the first substrate 111 due to the difference in refractive indices with the lens protection layer 600.

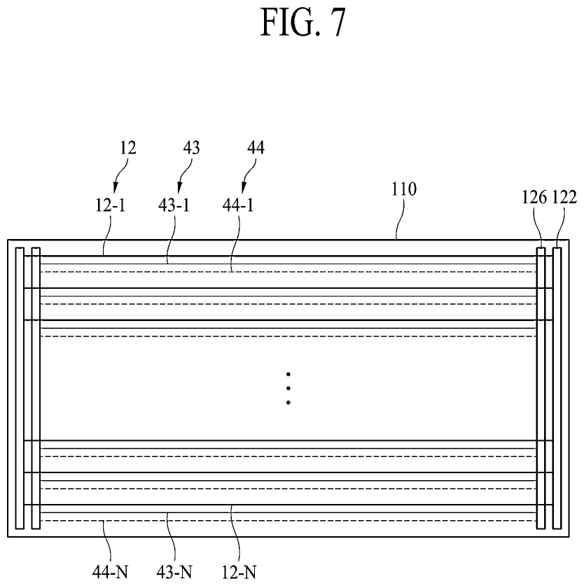

FIG. 6 is an equivalent circuit diagram illustrating a circuit configuration of each sub-pixel in a display panel, according to one example embodiment of the present disclosure.

Referring to FIG. 6, each sub-pixel SP1, SP2, and SP3 can include a pixel circuit 10 including a plurality of transistors DT and T1 to T8 and the first and second emitting elements ED1 and ED2.

The pixel circuit 10 illustrated in FIG. 6 can include eight switching transistors T1 to T8, a driving transistor DT, a storage capacitor Cst, and the first and second emitting elements ED1 and ED2 and it's not limited thereof. In FIG. 6, the first control transistor T6 can correspond to the first control transistor ET1 shown in FIG. 4, and the second control transistor T8 can correspond to the second control transistor ET2 shown in FIG. 5.

Each of the transistors DT and T1 to T8 of each sub-pixel SP includes a gate electrode, a source electrode, and a drain electrode. Since the source electrode and the drain electrode are not fixed and can be changed according to the direction of the voltage and current applied to the gate electrode, one of the source electrode and the drain electrode can be represented as a first electrode, and the other can be represented as a second electrode. The transistors DT and T1 to T8 of each sub-pixel SP can utilize at least one of a polysilicon semiconductor, an amorphous silicon semiconductor, and an oxide semiconductor. The transistors can be P-type or N-type, or a mixture of P-type and N-type.

The first electrode of the driving transistor DT can be connected to the first power line 32 that supplies the first power voltage EVDD. The first power voltage EVDD can be supplied from the power circuit 180 in FIG. 2. The second electrode of the driving transistor DT can be in common connected to the first electrodes of the first and second control transistors T6 and T8 through the fourth switching transistor T4. The driving transistor DT can drive the first emitting element ED1 through the fourth switching transistor T4 and the first control transistor T6, or can drive the second emitting element ED2 through the fourth switching transistor T4 and the second control transistor T8. The driving transistor DT can control the driving current according to the driving voltage Vg of the storage capacitor Cst. Thereby, the driving transistor DT can control the emission intensity of the first emitting element ED1 through the first control transistor T6, or can control the emission intensity of the second emitting element ED2 through the second control transistor T8.

The storage capacitor Cst can be charged with the drive voltage Vg corresponding to the data voltage Vdata. The storage capacitor Cst can supply the charged driving voltage Vg to the driving transistor DT.

The first switching transistor T1 can be turned on or turned off in response to a first scan signal SCAN1 supplied to the first scan line 12. The first switching transistor T1 can supply the data voltage Vdata supplied through the data line 22 to the first electrode of the storage capacitor Cst in response to the gate-on-voltage of the first scan signal SCAN1. The first scan signal SCAN1 can be supplied from the scan driver 122 in FIG. 2.

The second, fifth, and seventh switching transistors T2, T5, and T7 can be turned on or off in response to the second scan signal SCAN2 supplied to the second scan line 16. The second scan signal SCAN2 can be supplied from the scan driver 122 in FIG. 2.

The second switching transistor T2 can connect the gate electrode and the second electrode of the driving transistor DT in response to the gate-on-voltage of the second scan signal SCAN2 such that the driving transistor DT is connected as a diode structure. The second switching transistor T2 can charge and compensate the threshold voltage Vth of the driving transistor DT to the storage capacitor Cst. Accordingly, the storage capacitor Cst can charge a data voltage Vdata+Vth with which the threshold voltage Vth of the driving transistor DT is compensated.

The fifth switching transistor T5 can supply the initialization voltage Vref (or reference voltage) supplied through the initialization voltage line 24 to the anode electrode of the first emitting element ED1 in response to the gate-on-voltage of the second scan signal SCAN2.

The seventh switching transistor T7 can supply the initialization voltage Vref (or reference voltage) supplied through the initialization voltage line 24 to the anode electrode of the second emitting element ED2 in response to the gate-on-voltage of the second scan signal SCAN2.

The third and fourth switching transistors T3, T4 can be turned on or turned off in response to the emitting signal EM supplied to the emitting control line 42. The emitting signal EM can be supplied from the emitting control driver 124 in FIG. 2.

The third switching transistor T3 can supply the initialization voltage Vref (or reference voltage) supplied through the initialization voltage line 24 to the first electrode of the storage capacitor Cst in response to the gate-on-voltage of the emitting signal EM.

The fourth switching transistor T4 can connect the driving transistor DT and the first or second control transistors T6, T8 in response to the gate-on-voltage of the emitting signal EM.

The first and second control transistors T6, T8 can be controlled by the mode selection signals MS1 and MS2 supplied to the mode selection lines 43 and 44 to be turned on or turned off.

The first control transistor T6 can be controlled by the first mode selection signal MS1 supplied to the first mode selection line 43 to be turned on or turned off. The first control transistor T6 can be turned on when the first mode selection signal MS1 is the gate-on-voltage, thereby connecting the driving transistor DT and the first emitting element ED1. Accordingly, the first emitting element ED1 can be driven by the driving current from the driving transistor DT to emit light. The sub-pixels SP1, SP2, and SP3 can emit light at the first viewing angle through the first lens LZ1, and can operate in the first viewing angle mode, the wide viewing angle mode, or the share mode.

The second control transistor T8 can be controlled by the second mode selection signal MS2 supplied to the second mode selection line 44 to be turned on or turned off. The second control transistor T8 can be turned on when the second mode selection signal MS2 is the gate-on-voltage, thereby connecting the driving transistor DT and the second emitting element ED2. Accordingly, the second emitting element ED2 can be driven by the driving current from the driving transistor DT to emit light. The sub-pixels SP1, SP2, and SP3 can emit light at the second viewing angle through the second lens LZ2, and can operate in the second viewing angle mode, the narrow viewing angle mode, or the privacy mode.

Each of the emitting elements ED1 and ED2 can comprise an anode electrode individually connected to each of the control transistors T6 and T8, a cathode electrode receiving the second power voltage from the second power line 34, and a light emitting layer between the anode electrode and the cathode electrode. The anode electrode can be an independent electrode for each emitting element, while the cathode electrode can be a common electrode shared by all emitting elements. When a driving current is supplied to each of the emitting elements ED1 and ED2 from the driving transistor DT through each of the control transistors T6 and T8, electrons from the cathode electrode are injected into the light emitting layer, and holes from the anode electrode are injected into the light emitting layer, and the fluorescent or phosphorescent material can be emitted by the recombination of the electrons and holes in the light emitting layer, thereby generating light with a brightness proportional to the current value of the driving current.

The first emitting element ED1 can be driven using the first control transistor T6 controlled by the first mode selection signal MS1. Specifically, the first emitting element ED1 can be driven by being connected to the driving transistor DT when the first control transistor T6 is turned on by the first mode selection signal MS1 corresponding to the gate-on-voltage. The first lens LZ1 disposed in the light progress direction of the first emitting element ED1 can control the viewing angle to be the first viewing angle.

The second emitting element ED2 can be driven using the second control transistor T8 controlled by the second mode selection signal MS2. Specifically, the second emitting element ED2 can be driven by being connected to the driving transistor DT when the second control transistor T8 is turned on by the second mode selection signal MS2 corresponding to the gate-on-voltage. The second lens LZ2 disposed in the light progress direction of the second emitting element ED2 can be control the viewing angle to be the second viewing angle.

The display panel 110 according to one example embodiment of the present disclosure can select one of the first viewing angle mode and the second viewing angle mode as a viewing angle mode of each of the sub-pixels SP1, SP2, and SP3 by using the first and second mode selection signals MS1 and MS2. Each of the sub-pixels SP1, SP2, and SP3 provided in the display panel 110 according to one example embodiment of the present disclosure includes a first mode sub-pixel SP1-1, SP2-1, and SP3-1 having the first viewing angle and including the first emitting element ED1, and the second mode sub-pixel SP1-2, SP2-2, and SP3-2 having the second viewing angle and including the second emitting element ED2.

In each sub-pixel SP1, SP2, and SP3, only one of the first emitting element ED1 and the second emitting element ED2 can emit according to the mode selection signals MS1 and MS2 applied through the mode selection lines 43 and 44. In each sub-pixel SP1, SP2, and SP3, when the first control transistor T6 connected with the first emitting element ED1 is turned on by the first mode selection signal MS1, the first emitting element ED1 and the driving transistor DT are connected so that the first emitting element ED1 can emit. Meanwhile, in each of the sub-pixels SP1, SP2, and SP3, when the second control transistor T8 connected with the second emitting element ED2 is turned on by the second mode selection signal MS2, the second emitting element ED2 and the driving transistor DT are connected so that the second emitting element ED2 can emit light. In the display panel 110 according to one example embodiment of the present disclosure, since one of the first mode selection signal MS1 and the second mode selection signal MS2 is the gate-on-voltage as and the other is the gate-off-voltage, only one of the first emitting element ED1 and the second emitting element ED2 can emit.

The first emitting element ED1 and the second emitting element ED2 provided in the same sub-pixel SP1, SP2, and SP3 cannot emit simultaneously. The first mode selection signal MS1 can be activated according to the gate-on-voltage when the corresponding sub-pixel is controlled in the first viewing angle mode, the wide viewing angle mode, or the share mode. The first mode selection signal MS1 can be deactivated according to the gate-off-voltage when the corresponding sub-pixel is controlled in the second viewing angle mode, the narrow viewing angle mode, or the privacy mode. On the other hand, the second mode selection signal MS2 can be activated according to the gate-on-voltage when the corresponding sub-pixel is controlled in the second viewing angle mode, the narrow viewing angle mode, or the privacy mode. The second mode selection signal MS2 can be deactivated according to the gate-off-voltage when the corresponding sub-pixel is controlled to the first viewing angle mode, the wide viewing angle mode, or the share mode.

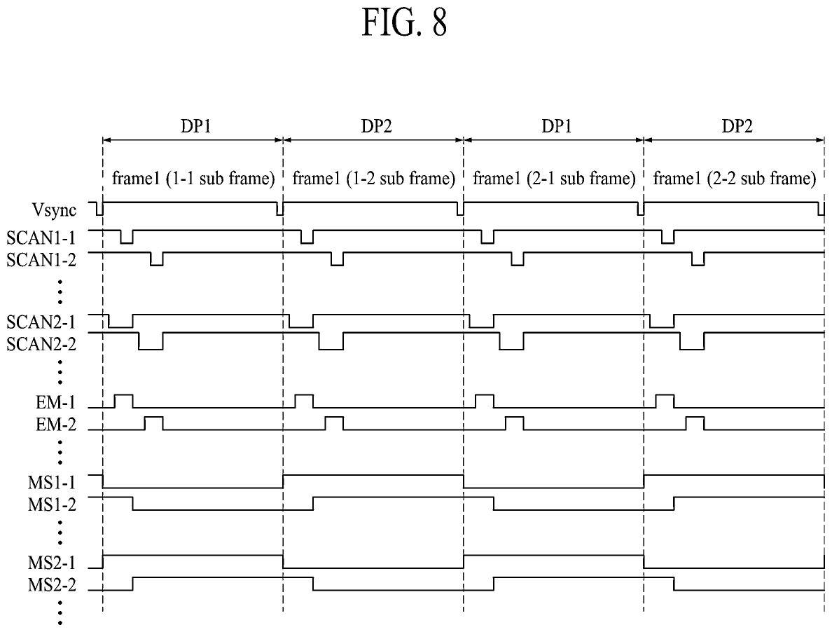

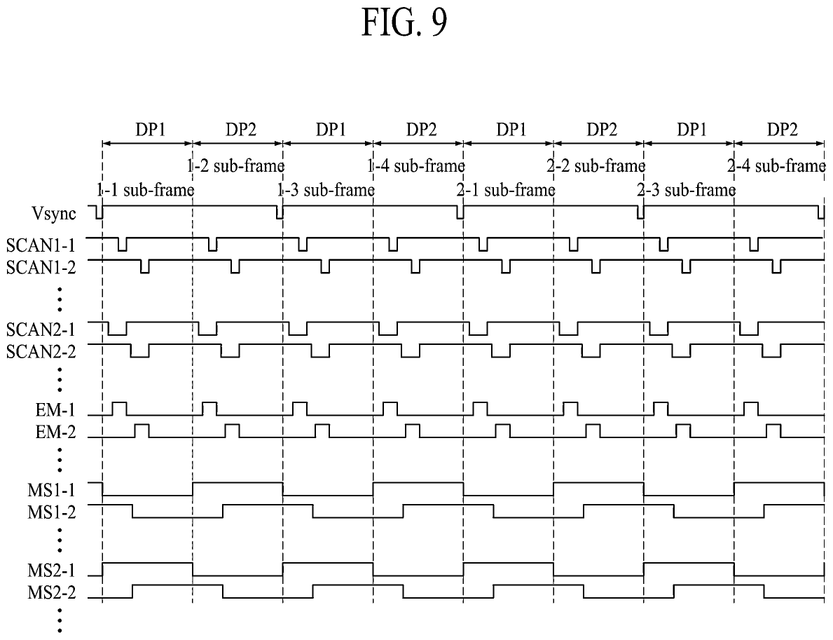

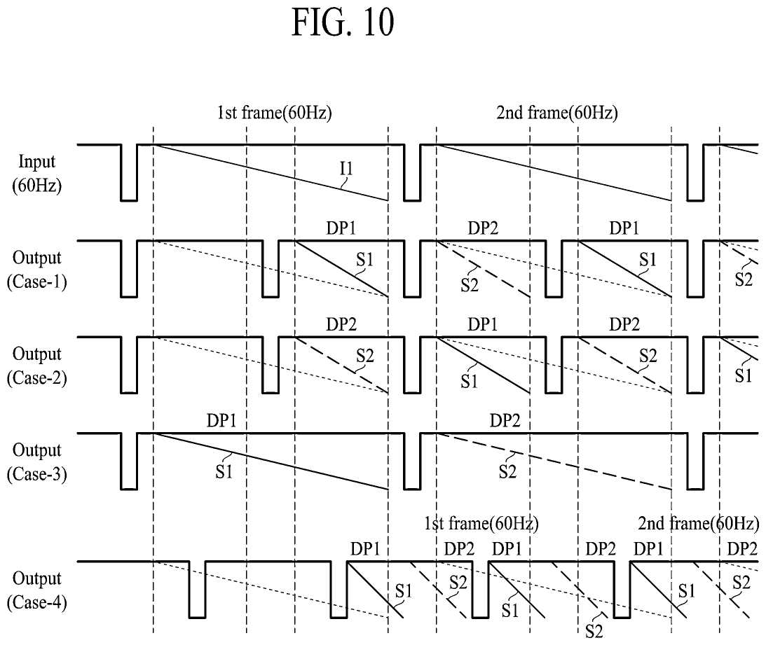

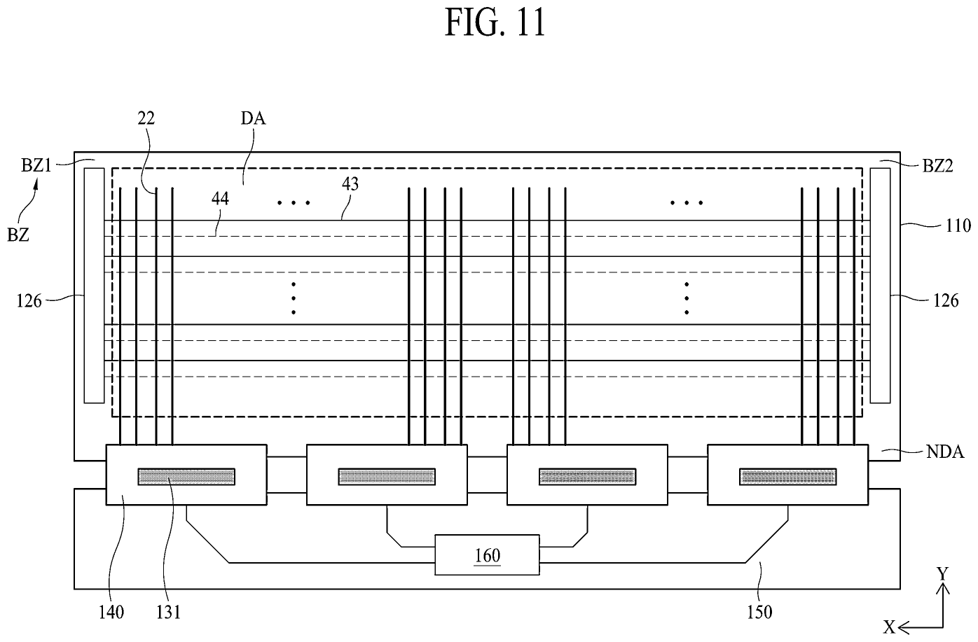

FIG. 7 is a plan view illustrating an example of a set of scan lines and mode selection lines disposed on a display panel, according to one example embodiment of the present disclosure, FIG. 8 is a diagram illustrating one example of a driving waveform for sub-pixels disposed on a display panel, according to one example embodiment of the present disclosure, and FIG. 9 is a diagram illustrating another example of a driving waveform for sub-pixels disposed on a display panel, according to one example embodiment of the present disclosure. FIG. 10 is a diagram illustrating various examples in which one frame is time-dived into a first display driving period and a second display driving period to be driven when an image data is input in frame units.

Referring to FIG. 7, in the display panel 110 according to one example embodiment of the present disclosure, the first mode selection line 43 and the second mode selection line 44 can be extended in a first direction (e.g., X-axis direction) parallel to the first scan line 12. The first mode selection line 43 and the second mode selection line 44 can be disposed on each of the plurality of row lines, and can be connected to the sub-pixels SP in FIG. 2 disposed on the row lines.

When the sub-pixels SP are disposed on N number of row lines, the first scan line 12 can include N number of first scan lines 12-1, . . . , and 12-N disposed on each of the N number of row lines. The scan driver 122 can sequentially supply a first scan signal SCAN1 to the N number of first scan lines 12-1, . . . , and 12-N. The first scan signal SCAN1 supplied to the N number of first scan lines 12-1, . . . , and 12-N can be supplied to sub-pixels SP disposed on the corresponding row lines.

The first mode selection line 43 can include N number of first mode selection lines 43-1, . . . , and 43-N disposed on each of the N number of row lines. The mode selection driver 126 can sequentially supply the first mode selection signal MS1 to the N number of first mode selection lines 43-1, . . . , and 43-N. The first mode selection signals MS1 supplied to the N number of first mode selection lines 43-1, . . . , and 43-N can be supplied to sub-pixels SP disposed on the corresponding row lines.

The second mode selection line 44 can include N number of second mode selection lines 44-1, . . . , and 44-N disposed on each of the N row lines. The mode selection driver 126 can sequentially supply the second mode selection signal MS2 to the N number of second mode selection lines 44-1, . . . , and 44-N. The second mode selection signals MS2 supplied to the N number of second mode selection lines 44-1, . . . , and 44-N can be supplied to sub-pixels SP disposed on the corresponding row lines.

Although not shown in FIG. 7, the display panel 110 can further include at least one of the second scan line 16 in FIG. 2 and the emitting control line 42 in FIG. 2, which are extending in the first direction (e.g., in the X-axis direction) parallel to the first scan line 12. The second scan line 16 can include the N number of second scan lines disposed on each of the N number of row lines. The scan driver 122 can sequentially supply the second scan signal SCAN2 to the N number of second scan lines 16. The second scan signals SCAN2 supplied to the N number of second scan lines 16 can be supplied to sub-pixels SP disposed on the corresponding row lines.

Further, the emitting control lines 42 can include N number of emitting control lines 42 disposed on each of the N number of row lines. The emitting control driver 124 in FIG. 2, can sequentially supply the emitting signal EM to the N number of control lines 42. The emitting signals EM supplied to the N number of emitting control lines 42 can be supplied to sub-pixels SP disposed on the corresponding row lines.

Referring to FIGS. 8 and 9, in the display panel 110 according to one example embodiment of the present disclosure, a display driving period can be driven in time-divided into a first display driving period DP1 and a second display driving period DP2. The first display driving period DP1 can be a period of displaying the first image through the first mode sub-pixels SP1-1, SP2-1, and SP3-1, and the second display operation period DP2 can be a period of displaying the second image through the second mode sub-pixels SP1-2, SP2-2, and SP3-2.

The first display driving period DP1 and the second display driving period DP2 can be synchronized with a plurality of frame periods frame1, frame2, frame3, and frame4. Each of the plurality of frame periods frame1, frame2, frame3, and frame4 can be separated in synchronization with a vertical synchronization signal VSYNC and can include a plurality of temporally separated sub-frame periods 1-1 sub-frame, 1-2 sub-frame, 2-1 sub-frame, and 2-2 sub-frame. Some (1-1 sub-frame and 2-1 sub-frame) of the plurality of sub-frame periods 1-1 sub-frame, 1-2 sub-frame, 2-1 sub-frame, and 2-2 sub-frame can correspond to a first display driving period DP1, and the others (1-2 sub-frame and 2-2 sub-frame) can correspond to a second display driving period DP2.

In the display panel 110 according to one example embodiment of the present disclosure, the first scan signal SCAN1, the second scan signal SCAN2, and the emitting signal EM can be supplied to the sub-pixels SP through each of the first scan line 12, the second scan line 16, and the emitting control line 42 during each of the first display driving period DP1 and the second display driving period DP2.

The scan driver 122 can sequentially activate the first scan signals SCAN1-1, SCAN1-2, . . . and SCAN1-N applied to the N number of first scan lines 12-1, . . . , and 12-N disposed on from the first row line to the Nth row line during each of the first display driving period DP1 and the second display driving period DP2. The first scan signals SCAN1-1, SCAN1-2, . . . and SCAN1-N can be activated with the gate-on-voltage.

As shown in FIG. 8, one sub-frame period 1-1 sub-frame, 1-2 sub-frame, 2-1 sub-frame, and 2-2 sub-frame can be equal to one frame period frame1, frame2, frame3, and frame4. In this example, the gate-on-voltage can be supplied to the sub-pixels SP every frame period frame1, frame2, frame3, and frame4 as the first scan signal SCAN1-1, SCAN1-2, . . . and SCAN1-N.

On the other hand, as shown in FIG. 9, one sub-frame period 1-1 sub-frame, 1-2 sub-frame, 2-1 sub-frame, and 2-2 sub-frame can correspond to 1/n of one frame period frame1, frame2, frame3, and frame4. Here, n can be any even number greater than zero. For example, n can be 2. In this example, the gate-on-voltage can be supplied to the sub-pixels SP every ½ frame period frame1, frame2, frame3, and frame4 as the first scan signal SCAN1-1, SCAN1-2, . . . and SCAN1-N

When the first scan signals SCAN1-1, SCAN1-2, . . . and SCAN1-N are activated with the gate-on-voltage, the first switching transistor T1 in FIG. 6 of each of the sub-pixels SP can be turned on to supply the data voltage Vdata supplied through the data line 22 in FIG. 6 to the first electrode of the storage capacitor Cst in FIG. 6.

As shown in FIGS. 8 and 9, the gate-on-voltage of the first scan signal SCAN1-1, SCAN1-2, . . . and SCAN1-N can be a low voltage but is not necessarily limited thereto. The gate-on-voltage of the first scan signal SCAN1-1, SCAN1-2, . . . and SCAN1-N can be a high voltage. In this example, the gate-off-voltage of the first scan signal SCAN1-1, SCAN1-2, . . . and SCAN1-N can be a low voltage.

Further, the scan driver 122 can sequentially activate second scan signals SCAN2-1, SCAN2-2, . . . , and SCAN2-N applied to the N number of second scan lines 16 in FIG. 2 disposed on from the first row line to the Nth row line during each of the first display driving period DP1 and the second display driving period DP2. The second scan signals SCAN2-1, SCAN2-2, . . . , and SCAN2-N can be activated by the gate-on-voltage.

When one sub-frame period 1-1 sub frame, 1-2 sub frame, 2-1 sub frame, and 2-2 sub frame is equal to one frame period frame1, frame2, frame3, and frame4 as illustrated in FIG. 8, the gate-on-voltage can be supplied to the sub-pixels SP as the second scan signal SCAN2-1, SCAN2-2, . . . , and SCAN2-N every frame period frame1, frame2, frame3, and frame4.

On the other hand, as shown in FIG. 9, one sub-frame period 1-1 sub-frame, 1-2 sub-frame, 2-1 sub-frame, and 2-2 sub-frame can correspond to 1/n of one frame period frame1, frame2, frame3, and frame4. For example, n can be 2. In this example, the gate-on-voltage can be supplied to the sub-pixels SP every ½ frame period frame1, frame2, frame3, and frame4 as the second scan signals SCAN2-1, SCAN2-2, . . . , and SCAN2-N.

When the second scan signals SCAN2-1, SCAN2-2, . . . , and SCAN2-N are activated with the gate-on-voltage, the second, fifth, and seventh switching transistors T2, T5, and T7, respectively, of the sub-pixels SPs in FIG. 6 can be turned on. The second switching transistor T2 can connect the driving transistor DT as a diode structure by connecting the gate electrode and the second electrode of the driving transistor DT in response to the gate-on-voltage of the second scan signal SCAN2-1, SCAN2-2, . . . , and SCAN2-N. The fifth switching transistor T5 can supply the initialization voltage Vref (or reference voltage) supplied through the initialization voltage line 24 to the anode electrode of the first emitting element ED1 in response to the gate-on-voltage of the second scan signal SCAN2-1, SCAN2-2, . . . , and SCAN2-N. Also, the seventh switching transistor T7 can supply the initialization voltage Vref (or reference voltage) supplied through the initialization voltage line 24 to the anode electrode of the second emitting element ED2 in response to the gate-on-voltage of the second scan signal SCAN2-1, SCAN2-2, . . . , and SCAN2-N.

As shown in FIGS. 8 and 9, the gate-on-voltage of the second scan signal SCAN2-1, SCAN2-2, . . . , and SCAN2-N can be a low voltage, but is not necessarily limited thereto. The gate-on-voltage of the second scan signal SCAN2-1, SCAN2-2, . . . , and SCAN2-N can be a high voltage. In this example, the gate-off-voltage of the second scan signal SCAN2-1, SCAN2-2, . . . , and SCAN2-N can be a low voltage.

The emitting control driver 124 can sequentially activate emitting signals EM-1, EM-2, . . . , and EM-N applied to the N number of emitting control lines 42 disposed from the first row line to the Nth row line during each of the first display driving period DP1 and the second display driving period DP2. The emitting signals EM-1, EM-2, . . . , and EM-N can be activated by the gate-on-voltage.

As shown in FIG. 8, when one sub-frame period 1-1 sub-frame, 1-2 sub-frame, 2-1 sub-frame, and 2-2 sub-frame is equal to one frame period frame1, frame2, frame3, and frame4, the gate-on-voltage can be supplied to the sub-pixels SP as the emitting signals EM-1, EM-2, . . . , and EM-N every frame period frame1, frame2, frame3, and frame4.

On the other hand, as shown in FIG. 9, one sub-frame period 1-1 sub-frame, 1-2 sub-frame, 2-1 sub-frame, and 2-2 sub-frame can correspond to 1/n of one frame period frame1, frame2, frame3, and frame4. For example, n can be 2. In this example, the gate-on-voltage can be supplied to the sub-pixels SP as the emitting signals EM-1, EM-2, . . . , and EM-N every ½ frame period frame1, frame2, frame3, and frame4.

When the emitting signals EM-1, EM-2, . . . , EM-N are activated with the gate-on-voltage, the third and fourth switching transistors T3 and T4 in FIG. 6 of each of the sub-pixels SP can be turned on. The third switching transistor T3 can supply the initialization voltage Vref (or reference voltage) supplied through the initialization voltage line 24 to the first electrode of the storage capacitor Cst in response to the gate-on-voltage of the emitting signals EM-1, EM-2, . . . , and EM-N. The fourth switching transistor T4 can connect the driving transistor DT and the first or second control transistors T6 or T8 in response to the gate-on-voltage of the emitting signals EM-1, EM-2, . . . , and EM-N.

As shown in FIGS. 8 and 9, the gate-on-voltage of the emitting signal EM-1, EM-2, . . . , and EM-N can be a low voltage, but is not necessarily limited thereto. The gate-on-voltage of the emitting signal EM-1, EM-2, . . . , and EM-N can be a high voltage. In this example, the gate-off-voltage of the emitting signal EM-1, EM-2, . . . , and EM-N can be a low voltage.

In the display panel 110 according to one example embodiment of the present disclosure, the first mode selection signal MS1 can be supplied to the sub-pixels SP through the first mode selection line 43 during the first display driving period DP1. On the other hand, in the display panel 110 according to one example embodiment of the present disclosure, the second mode selection signal MS2 can be supplied to the sub-pixels SP through the second mode selection line 44 during the second display driving period DP2.

The mode selection driver 126 can sequentially activate the first mode selection signals MS1-1, MS1-2, . . . , and MS1-N applied to the N number of first mode selection lines 43-1, . . . , and 43-N disposed from the first row line to the Nth row line during the first display driving period DP1. The first mode selection signals MS1-1, MS1-2, . . . , and MS1-N can be activated by the gate-on-voltage.

The first mode selection signals MS1-1, MS1-2, . . . , and MS1-N can have a different waveform from the emitting signals EM-1, EM-2, . . . , and EM1-N. The emitting signals EM-1, EM-2, . . . , and EM-N can be switched from the gate-off-voltage to the gate-on-voltage during each of the first display driving period DP1 and the second display driving period DP2, and the gate-on-voltage can be applied during the first period. The gate-off-voltage can be applied as the emitting signals EM-1, EM-2, . . . , and EM-N during the remaining periods. The first period can be shorter than one frame period frame1, frame2, frame3, and frame4, and can be shorter than one sub-frame period 1-1 sub-frame, 1-2 sub-frame, 2-1 sub-frame, and 2-2 sub-frame.

The first mode selection signals MS1-1, MS1-2, . . . , and MS1-N can be switched from the gate-off-voltage to the gate-on-voltage only during the first display driving period DP1, unlike the emitting signals EM-1, EM-2, . . . , EM-N. The gate-on-voltage is applied as the first mode selection signals MS1-1, MS1-2, . . . and MS1-N during the second period, and the first mode selection signals MS1-1, MS1-2, . . . and MS1-N can be switched from the gate-on-voltage to the gate-off-voltage during the second display driving period DP2. The second period can be longer than the first period. The second period can be equal to one sub-frame period 1-1 sub-frame, 1-2 sub-frame, 2-1 sub-frame, and 2-2 sub-frame.

The first mode selection signals MS1-1, MS1-2, . . . and MS1-N can have a periodic waveform in which the gate-on-voltage and the gate-off-voltage are repeated in sub-frame units. As illustrated in FIG. 8, one sub-frame period 1-1 sub-frame, 1-2 sub-frame, 2-1 sub-frame, and 2-2 sub-frame can be equal to one frame period frame1, frame2, frame3, and frame4. In this example, the first mode selection signals MS1-1, MS1-2, . . . , and MS1-N can be activated with the gate-on-voltage for one frame period, switched to the gate-off-voltage, and then deactivated with the gate-off-voltage for one frame period. That is, the first mode selection signals MS1-1, MS1-2, . . . , and MS1-N can be switched from the gate-off-voltage to the gate-on-voltage every two frame periods frame1, frame2, frame3, and frame4 to supply the sub-pixels SP with the gate-on-voltage for one frame period. Further, the first mode selection signals MS1-1, MS1-2, . . . , and MS1-N can be switched from the gate-on-voltage to the gate-off-voltage every two frame periods frame1, frame2, frame3, and frame4 to supply the gate-off-voltage to the sub-pixels SP for one frame period.

Alternatively, as shown in FIG. 9, one sub-frame period 1-1 sub-frame, 1-2 sub-frame, 2-1 sub-frame, and 2-2 sub-frame can correspond to 1/n of one frame period frame1, frame2, frame3, and frame4. In one example, said n can be 2. In this example, the first mode selection signals MS1-1, MS1-2, . . . , and MS1-N can be activated with the gate-on-voltage for a period of ½ frame, switched to the gate-off-voltage, and then deactivated with the gate-off-voltage for a period of ½ frame. That is, the first mode selection signals MS1-1, MS1-2, . . . , and MS1-N can be switched from the gate-off-voltage to the gate-on-voltage every one frame period frame1, frame2, frame3, and frame4 to supply the gate-on-voltage to the sub-pixels SP for a period of ½ frame. Further, the first mode selection signals MS1-1, MS1-2, . . . , and MS1-N can be switched from the gate-on-voltage to the gate-off-voltage every one frame period frame1, frame2, frame3, and frame4 to supply the gate-off-voltage to the sub-pixels SP for a ½ frame period.

When the first mode selection signals MS1-1, MS1-2, . . . , and MS1-N are activated with the gate-on-voltage, the first control transistor T6 in FIG. 6 of each of the sub-pixels SP can be turned on. The first control transistor T6 can be turned on when the first mode selection signals MS1-1, MS1-2, . . . , and MS1-N are the gate-on-voltage, thereby connecting the driving transistor DT and the first emitting element ED1. Accordingly, the first emitting element ED1 can be driven by the driving current from the driving transistor DT to emit light.

As shown in FIGS. 8 and 9, the gate-on-voltage of the first mode selection signal MS1-1, MS1-2, . . . , and MS1-N can be a low voltage but is not necessarily limited thereto. The gate-on-voltage of the first mode selection signal MS1-1, MS1-2, . . . , and MS1-N can be a high voltage. In this example, the gate-off-voltage of the first mode selection signal MS1-1, MS1-2, . . . , and MS1-N can be a low voltage.

Further, the mode selection driver 126 can sequentially activate the second mode selection signals MS2-1, MS2-2, . . . , and MS2-N applied to the N number of second mode selection lines 44-1, . . . , and 44-N disposed from the first row line to the Nth row line during the second display driving period DP2. The second mode selection signals MS2-1, MS2-2, . . . , and MS2-N can be activated by a gate-on-voltage.

The second mode selection signals MS2-1, MS2-2, . . . , and MS2-N can have a different waveform from the emitting signals EM-1, EM-2, . . . , and EM-N The emitting signals EM-1, EM-2, . . . , and EM-N can be switched from the gate-off-voltage to the gate-on-voltage during each of the first display driving period DP1 and the second display driving period DP2, and the gate-on-voltage can be applied during the first period. The gate-off-voltage can be applied as the emitting signals EM-1, EM-2, . . . , EN-M during the remaining periods. The first period can be shorter than one frame period frame1, frame2, frame3, and frame4, and can be shorter than one sub-frame period 1-1 sub-frame, 1-2 sub-frame, 2-1 sub-frame, and 2-2 sub-frame.

The second mode selection signals MS2-1, MS2-2, . . . , and MS2-N can be switched from the gate-off-voltage to the gate-on-voltage only during the second display driving period DP2, unlike the emitting signals EM-1, EM-2, . . . , EM-N. The gate-on-voltage can be supplied as the second mode selection signals MS2-1, MS2-2, . . . , and MS2-N during the third period, and the second mode selection signals MS2-1, MS2-2, . . . , and MS2-N can be switched from the gate-on-voltage to the gate-off-voltage during the first display driving period DP1. The third period can be longer than the first period. The third period can be equal to one of the sub-frame periods 1-1 sub-frame, 1-2 sub-frame, 2-1 sub-frame, and 2-2 sub-frame. Further, the third period can be equal to the second period that is a gate-on-voltage period of the first mode selection signal MS1-1, MS1-2, . . . , and MS1-N.

The second mode selection signals MS2-1, MS2-2, . . . , and MS2-N can have a periodic waveform in which the gate-on-voltage and the gate-off-voltage are repeated in sub-frame units. As illustrated in FIG. 8, one sub-frame period 1-1 sub-frame, 1-2 sub-frame, 2-1 sub-frame, and 2-2 sub-frame can be equal to one frame period frame1, frame2, frame3, and frame4. In this example, the second mode selection signals MS2-1, MS2-2, . . . , and MS2-N can be activated with the gate-on-voltage for one frame period, switched to the gate-off-voltage, and then deactivated with the gate-off-voltage for one frame period. That is, the second mode selection signals MS2-1, MS2-2, . . . , and MS2-N can be switched from the gate-off-voltage to the gate-on-voltage every two frame periods frame1, frame2, frame3, and frame4 to supply the sub-pixels SP with the gate-on-voltage for one frame period. In addition, the second mode selection signals MS2-1, MS2-2, . . . , and MS2-N can be switched from the gate-on-voltage to the gate-off-voltage every two frame periods frame1, frame2, frame3, and frame4 to supply the gate-off-voltage to the sub-pixels SP for one frame period.

Alternatively, as shown in FIG. 9, one sub-frame period 1-1 sub-frame, 1-2 sub-frame, 2-1 sub-frame, and 2-2 sub-frame can correspond to 1/n of one frame period frame1, frame2, frame3, and frame4. In one example, the n can be 2. In this example, the second mode selection signals MS2-1, MS2-2, . . . , and MS2-N can be activated with the gate-on-voltage for a ½ frame period, switched to the gate-off-voltage, and then deactivated with the gate-off-voltage for a ½ frame period. That is, the second mode selection signals MS2-1, MS2-2, . . . , and MS2-N can switch from the gate-off-voltage to the gate-on-voltage every one frame period frame1, frame2, frame3, and frame4 to supply the gate-on-voltage to the sub-pixels SP for a ½ frame period. Further, the second mode selection signals MS2-1, MS2-2, . . . , and MS2-N can be switched from the gate-on-voltage to the gate-off-voltage every one of the frame periods frame1, frame2, frame3, and frame4 to supply the gate-off-voltage to the sub-pixels SP for a ½ frame period.

When the second mode selection signals MS2-1, MS2-2, . . . , and MS2-N are activated with the gate-on-voltage, the second control transistor T8 in FIG. 6 of each of the sub-pixels SP can be turned on. The second control transistor T8 can be turned on when the second mode selection signals MS2-1, MS2-2, . . . , and MS1-N are the gate-on-voltage, thereby connecting the driving transistor DT and the second emitting element ED2. Accordingly, the second emitting element ED2 can be driven by the driving current from the driving transistor DT to emit light.

As shown in FIGS. 8 and 9, the gate-on-voltage of the second mode selection signal MS2-1, MS2-2, . . . , and MS2-N can be a low voltage but is not necessarily limited thereto. The gate-on-voltage of the second mode selection signal MS2-1, MS2-2, . . . , and MS2-N can be a high voltage. In this example, the gate-off-voltage of the second mode selection signal MS2-1, MS2-2, . . . , and MS2-N can be a low voltage.

The first mode selection signals MS1-1, MS1-2, . . . , and MS1-N and the second mode selection signals MS2-1, MS2-2, . . . , and MS2-N have a periodic waveform in which the gate-on-voltage and the gate-off-voltage are repeated in sub-frame units, and can have an opposite phase with each other. Accordingly, the first emitting element ED1 of the first mode sub-pixels SP1-1, SP2-1, and SP3-1 and the second emitting element ED2 of the second mode sub-pixels SP1-2, SP2-2, and SP3-2 included in the same sub-pixel SP do not emit simultaneously, and one of them can emit selectively. That is, the first emitting element ED1 of the first mode sub-pixel SP1-1, SP2-1, and SP3-1 can emit during the first display driving period DP1 and not emit during the second display driving period DP2. The second emitting element ED2 of the second mode sub-pixel SP1-2, SP2-2, and SP3-2 can emit during the second display driving period DP2 and not emit during the first display driving period DP1.

In the display panel 110 according to one example embodiment of the present disclosure, the display driving period can be driven in time-divided into the first display driving period DP1 and the second display driving period DP2. The first mode selection signals MS1-1, MS1-2, . . . , and MS1-N are activated during the first display driving period DP1, and the first emitting elements ED1 of each of the first mode sub-pixels SP1-1, SP2-1, and SP3-1 can emit. Accordingly, in the display panel 110 according to one example embodiment of the present disclosure, the first image can be displayed through the first mode sub-pixels SP1-1, SP2-1, and SP3-1 during the first display driving period DP1. The first image can be an image in the first viewing angle mode, the wide viewing angle mode, or the share mode.

On the other hand, during the second display driving period DP2, the second mode selection signals MS2-1, MS2-2, . . . , and MS2-N can be activated, thus the second emitting elements ED2 of each of the second mode sub-pixels SP1-2, SP2-2, and SP3-2 can emit. Accordingly, in the display panel 110 according to one example embodiment of the present disclosure, the second image can be displayed through the second mode sub-pixels SP1-2, SP2-2, and SP3-2 during the second display driving period DP2. The second image can be an image in the second viewing angle mode, the narrow viewing angle mode, or the privacy mode.

The display panel 110 according to one example embodiment of the present disclosure can receive the first pixel data for the first image and the second pixel data for the second image from the timing controller 160.

Specifically, the display panel 110 according to one example embodiment of the present disclosure can supply a data voltage corresponding to the first pixel data to the first mode sub-pixels SP1-1, SP2-1, and SP3-1 through the data line 22 during the first display driving period DP1.

Further, the display panel 110 according to one example embodiment of the present disclosure can supply data voltages corresponding to the second pixel data to the second mode sub-pixels SP1-2, SP2-2, and SP3-2 through the data lines 22 during in the second display driving period DP2.

As shown in FIG. 10, the display panel 110 according to one example embodiment of the present disclosure can receive input of one frame of image data at a rate of 60 Hz from the timing controller 160. In this example, the image data can include the first pixel data and the second pixel data.

On the other hand, the display panel 110 according to one example embodiment of the present disclosure can output the first pixel data and the second pixel data to the sub-pixels SP at a rate of 120 Hz, which is twice as fast as the rate at which the image data is input. In the display panel 110 according to one example embodiment of the present disclosure, the first display driving period DP1 and the second display driving period DP2 can operate so as to be delayed by ½ frame compared to input the image data. This is to prevent the input points I1 at which the image data for each row line is input from intersecting with the start points S1 or S2 at which the image data for each row line is output when the image data of one frame is input.

Each of the first display driving period DP1 and the second display driving period DP2 can have a period that is shorter than the frame period in which the image data is input. For example, as illustrated in FIG. 10, each of the first display driving period DP1 and the second display driving period DP2 can have a period of half the period of the frame in which the image data is input.

As shown in Case-1 of FIG. 10, in the display panel 110 according to one example embodiment of the present disclosure, the first display driving period DP1 can operate so as to be delayed by a ½ frame compared to input the image data, and then the second display driving period DP2 can operate. In this example, the display panel 110 according to one example embodiment of the present disclosure can output the first pixel data by row line during the first display driving period DP1. In the display panel 110 according to one example embodiment of the present disclosure, the first mode sub-pixels SP1-1, SP2-1, and SP3-1 are supplied with the first pixel data to display the first image. At this time, the start points S1 at which the first pixel data is output for each row line cannot intersect with the input points I1 at which the image data is input for each row line.

Then, the display panel 110 according to one example embodiment of the present disclosure can output the second pixel data for each row line during the second display driving period DP2. In the display panel 110 according to one example embodiment of the present disclosure, the second mode sub-pixels SP1-2, SP2-2, and SP3-2 are supplied with the second pixel data to display the second image. At this time, the start points S2 at which the second pixel data is output for each row line cannot intersect with the input points I1 at which the image data is input for each row line.

In the display panel 110 according to one example embodiment of the present disclosure, since the first pixel data can be output during one first display driving period DP1 and the second pixel data can be output during one second display driving period DP2, an image corresponding to one frame of image data input from the timing controller 160 can be displayed.

Alternatively, as shown in Case-2 of FIG. 10, in the display panel 110 according to one example embodiment of the present disclosure, the second display driving period DP2 can operate so as to be delayed a ½ frame compared to input the image data, and then the first display driving period DP1 can operate. In this example, the display panel 110 according to one example embodiment of the present disclosure can output the second pixel data for each row line during the second display driving period DP2. In the display panel 110 according to one example embodiment of the present disclosure, the second mode sub-pixels SP1-2, SP2-2, and SP3-2 are supplied with the second pixel data to display the second image. At this time, the start points S2 at which the second pixel data is output for each row line cannot intersect with the input points I1 at which the image data is input for each row line.

Then, the display panel 110 according to one example embodiment of the present disclosure can output the first pixel data for each row line during the first display driving period DP1. In the display panel 110 according to one example embodiment of the present disclosure, the first mode sub-pixels SP1-1, SP2-1, and SP3-1 are supplied with the first pixel data to display the first image. At this time, the start points S1 at which the first pixel data is output for each row line cannot intersect with the input points I1 at which the image data is input for each row line.

In the display panel 110 according to one example embodiment of the present disclosure, since the second pixel data can be output during one second display driving period DP2 and the first pixel data can be output during one first display driving period DP1, an image corresponding to one frame of image data input from the timing controller 160 can be displayed.

Case-1 and Case-2 of FIG. 10 illustrate that a rate at which the image data is input and a rate at which the first pixel data and the second pixel data are output to the sub-pixels SPs are different, but it is not necessarily limited to. As another example, as shown in Case-3 of FIG. 10, the display panel 110 according to one example embodiment of the present disclosure can output the first pixel data and the second pixel data to the sub-pixels SPs at a rate of 60 Hz, the same as the rate at which the image data is input.

Furthermore, Case-1 and Case-2 of FIG. 10 illustrate that each of the first display driving period DP1 and the second display driving period DP2 has a period of half of the frame period in which the image data is input, but it is not necessarily limited to. As another example, as shown in Case-4 of FIG. 10, in the display panel 110 according to one example embodiment of the present disclosure, each of the first display driving period DP1 and the second display driving period DP2 can have a period of a quarter of the frame period in which the image data is input.

In this example, in the display panel 110 according to one example embodiment of the present disclosure, the first display driving period DP1 and the second display driving period DP2 can operate so as to be delayed by three-quarters of a frame compared to input the image data. This is to prevent the time input points I1 at which the image data is input for each row line from intersecting with the start points S1 or S2 at which the image data is output for each row line.

As shown in Case-4 of FIG. 10, in the display panel 110 according to one example embodiment of the present disclosure, the first display driving period DP1 can operate so as to be delayed by three quarters of a frame compared to input the image data, and then the second display driving period DP2 can operate. Then, the first display driving period DP1 can be operated again, followed by the second display driving period DP2.

The display panel 110 according to one example embodiment of the present disclosure can display an image corresponding to one frame of image data input from the timing controller 160 by outputting the same first pixel data in two first display driving periods DP1 and outputting the same second pixel data in two second display driving periods DP2.

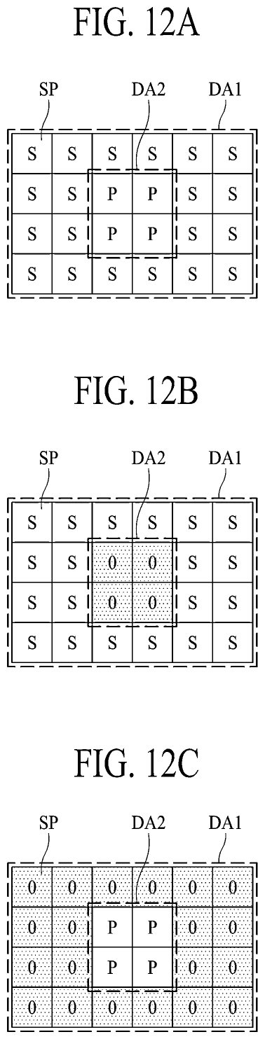

On the other hand, the display panel 110 according to one example embodiment of the present disclosure can implement some area of the display area DA in the first viewing angle mode, the wide viewing angle mode, or the share mode, and implement the remaining area in the second viewing angle mode, the narrow viewing angle mode, or the privacy mode using the first pixel data and the second pixel data. This will be described further with reference to FIGS. 11 through 14B.

FIG. 11 is a plan view illustrating an example of mode selection lines and data lines disposed on a display panel, according to one example embodiment of the present disclosure.

Referring to FIG. 11, the display panel 110 according to one example embodiment of the present disclosure can have the first mode selection line 43 and the second mode selection line 44 extending in the first direction (e.g., in the X-axis direction). The first mode selection line 43 and the second mode selection line 44 can be disposed on each of a plurality of row lines and can be connected to sub-pixels SP in FIG. 2 disposed on the row lines.

The first mode selection line 43 can be supplied with the first mode selection signal from the mode selection driver 126. The second mode selection line 44 can be supplied with the second mode selection signal from the mode selection driver 126. The first mode selection signal can be activated during the first display driving period DP1 and deactivated during the second display driving period DP2. The second mode selection signal can be activated during the second display period DP2 and deactivated during the first display period DP1.

On the other hand, the display panel 110 according to one example embodiment of the present disclosure can have data lines 22 extending in the second direction (e.g., in the Y-axis direction). The data lines 22 can be disposed on each of the plurality of column lines, and can be connected to sub-pixels SP in FIG. 2 disposed on the column lines.

The data line 22 can receive a data voltage Vdata from the data drive IC 131. The data drive IC 131 can receive the pixel data and the data control signals from the timing controller 160. In this example, the pixel data can include the first pixel data for the first mode sub-pixels SP1-1, SP2-1, and SP3-1 and the second pixel data for the second mode sub-pixels SP1-2, SP2-2, and SP3-2.

The timing controller 160 can generate the first pixel data and the second pixel data using digital video data input from the external host system. In one example, the external host system can transmit first digital video data including information about the first image and second digital video data including information about the second image to the timing controller 160. In this example, the timing controller 160 can align the first digital video data and convert it to the first pixel data and can align. The timing controller 160 can align the second digital video data and convert it to the second pixel data. The timing controller 160 can supply the first pixel data and the second pixel data with the data control signal to the data drive IC 131.

In another example, the external host system can transmit to the timing controller 160 one digital video data in which a first video and a second video are integrated, together with position information of an area in which the first image or the second image is displayed. In this example, the timing controller 160 can convert the digital video data into the first pixel data and the second pixel data using the position information of the area in which the first image or the second image is displayed. The timing controller 160 can supply the first pixel data and the second pixel data with a data control signal to the data drive IC 131.

The data drive IC 131 can convert the first pixel data and the second pixel data into analog positive/negative data voltages Vdata using the data control signals and supply them to the sub-pixels SP through the data lines 22.

The data drive IC 131 can supply a data voltage corresponding to the first pixel data to each of the plurality of column lines during the first display driving period DP1. Also, the data drive IC 131 can supply a data voltage corresponding to the second pixel data to each of the plurality of column lines during the second display driving period DP2.

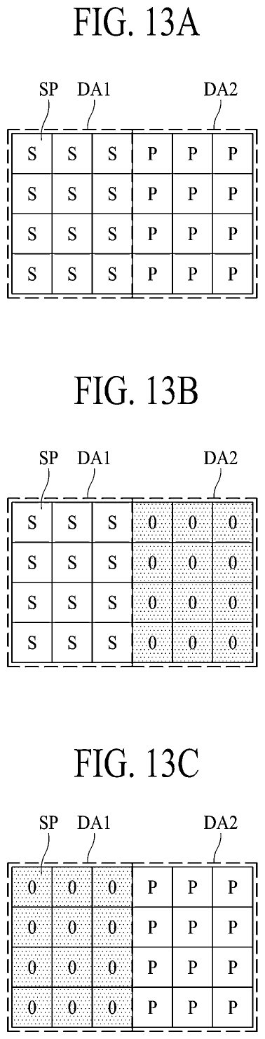

FIG. 12A is a diagram illustrating one example of a first mode display area and a second mode display area, FIG. 12B is a diagram illustrating one example of first pixel data input in a first display driving period, and FIG. 12C is a diagram illustrating an example of second pixel data input in the second display driving period.

In FIGS. 12A to 12C, it is assumed that 24 sub-pixels SPs are disposed in the display area DA for convenience of description. The display area DA can include a first mode display area DA1 for displaying the first image through the first mode sub-pixels SP1-1, SP2-1, and SP3-1, and a second mode display area DA2 for displaying the second image through the second mode sub-pixels SP1-2, SP2-2, and SP3-2. The first mode display area DA1 can be an area implemented in the first viewing angle mode, the wide viewing angle mode, or the share mode. The second mode display area DA2 can be implemented in the second viewing angle mode, the narrow viewing angle mode, or the privacy mode.

The first mode display area DA1 and the second mode display area DA2 cannot overlap each other, and can have different sizes. DA2. FIGS. 12A to 12C illustrate that both the first mode display area DA1 and the second mode display area DA2 are included, but it is not necessarily limited to. In another example, the display area DA can include only the first mode display area DA1 or only the second mode display area DA2. The display area DA can include at least one of the first mode display area DA1 and the second mode display area DA2, depending on user selection or user settings. Further, the first mode display area DA1 and the second mode display area DA2 cannot be fixed in position and size, and can be determined by user selection or user setting.

As shown in FIG. 12A, the display panel 110 can determine the area in which the middle four sub-pixels SP are disposed as the second mode display area DA2, and the area in which the remaining sub-pixels SP are disposed as the first mode display area DA1 according to user selection or user setting.

The display panel 110 can supply a data voltage corresponding to the first pixel data to the first mode sub-pixels SP1-1, SP2-1, and SP3-1 during the first display driving period. The first pixel data can include a pixel data for displaying the first image for the first mode sub-pixels SP1-1, SP2-1, and SP3-1 of each of the sub-pixels disposed in the first mode display area DA1. On the other hand, as shown in FIG. 12B, the first pixel data can have a black data for the first mode sub-pixels SP1-1, SP2-1, and SP3-1 of each of the four sub-pixels SPs disposed in the second mode display area DA2. The black data can be ‘0’. Thus, the second mode display area DA2 can display only black image during the first display driving period. That is, the display panel 110 cannot display an image in the second mode display area DA2 during the first display driving period.

On the other hand, the display panel 110 can supply a data voltage corresponding to the second pixel data to the second mode sub-pixels SP1-2, SP2-2, and SP3-2 during the second display driving period. The second pixel data can include a pixel data for displaying the second image for the second mode sub-pixels SP1-2, SP2-2, and SP3-2 of each of the sub-pixels disposed in the second mode display area DA2. On the other hand, as shown in FIG. 12C, the second pixel data can have black data for the second mode sub-pixels SP1-2, SP2-2, and SP3-2 of each of the sub-pixels SP disposed in the first mode display area DAL. The black data can be ‘0’. Thus, the first mode display area DA1 can display only a black image during the second display operation period. That is, the display panel 110 cannot display an image in the first mode display area DA1 during the second display operation period.

As a result, in the display panel 110, the first image can be displayed through the first mode sub-pixels SP1-1, SP2-1, and SP3-1 in the first mode display area DA1 and the second image can be displayed through the second mode sub-pixels SP1-2, SP2-2, and SP3-2 in the second mode display area DA2, during the first display driving period and the second display driving period alternately repeated. The first image is displayed through the first mode sub-pixels SP1-1, SP2-1, and SP3-1 in the first mode display area DA1, thus the first viewing angle mode, the wide viewing angle mode, or the share mode can be implemented. The second mode display area DA2 can display the second image through the second mode sub-pixels SP1-2, SP2-2, and SP3-2, thus the second viewing angle mode, the narrow viewing angle mode, or the privacy mode can be implemented.

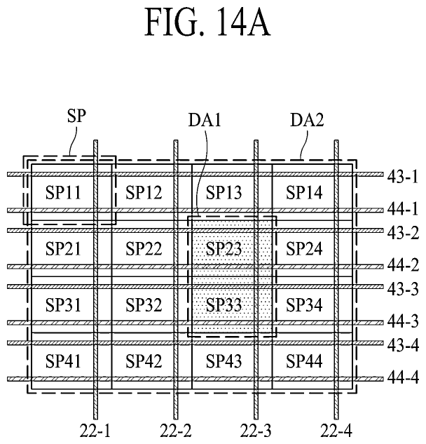

FIG. 13A is a diagram illustrating another example of a first mode display area and a second mode display area, FIG. 13B is a diagram illustrating another example of first pixel data being input in the first display driving period, and FIG. 13C is a diagram illustrating another example of second pixel data being input in the second display driving period.

As shown in FIG. 13A, in the display panel 110, an area in which the 12 sub-pixels SPs on the left side are disposed can be determined as the first mode display area DA1, and an area in which the 12 sub-pixels SPs on the right side are disposed can be determined as the second mode display area DA2, according to user selection or user setting.

The display panel 110 can supply a data voltage corresponding to the first pixel data to the first mode sub-pixels SP1-1, SP2-1, and SP3-1 during the first display driving period. The first pixel data can include a pixel data for displaying the first image for the first mode sub-pixels SP1-1, SP2-1, and SP3-1 of each of the twelve sub-pixels on the left side disposed in the first mode display area DAL. On the other hand, as shown in FIG. 13B, the first pixel data can have black data for the first mode sub-pixels SP1-1, SP2-1, and SP3-1 of each of the twelve sub-pixels SPs on the right side disposed in the second mode display area DA2. The black data can be ‘0’. Thus, the second mode display area DA2 can display only a black image during the first display driving period. That is, the display panel 110 cannot display an image in the second mode display area DA2 during the first display driving period.

Meanwhile, the display panel 110 can supply a data voltage corresponding to the second pixel data to the second mode sub-pixels SP1-2, SP2-2, and SP3-2 during the second display driving period. The second pixel data can include a pixel data for displaying the second image for the second mode sub-pixels SP1-2, SP2-2, and SP3-2 of each of the twelve sub-pixels on the left side disposed in the second mode display area DA2. On the other hand, as shown in FIG. 13C, the second pixel data can have black data for the second mode sub-pixel SP1-2, SP2-2, and SP3-2 of each of the twelve sub-pixels SPs on the right side disposed in the first mode display area DAL. The black data can be ‘0’. Thus, the first mode display area DA1 can display only a black image during the second display operation period. That is, the display panel 110 cannot display an image in the first mode display area DA1 during the second display operation period.

As a result, in the display panel 110, the first image can be displayed through the first mode sub-pixels SP1-1, SP2-1, and SP3-1 in the first mode display area DA1, and the second image can be displayed through the second mode sub-pixels SP1-2, SP2-2, and SP3-2 in the second mode display area DA2, during the first display driving period and the second display driving period alternately repeated. The first image is displayed through the first mode sub-pixels SP1-1, SP2-1, and SP3-1 in the first mode display area DA1, thus the first viewing angle mode, the wide viewing angle mode, or the share mode can be implemented. The second mode display area DA2 can display the second image through the second mode sub-pixels SP1-2, SP2-2, and SP3-2, thus the second viewing angle mode, the narrow viewing angle mode, or the privacy mode can be implemented.

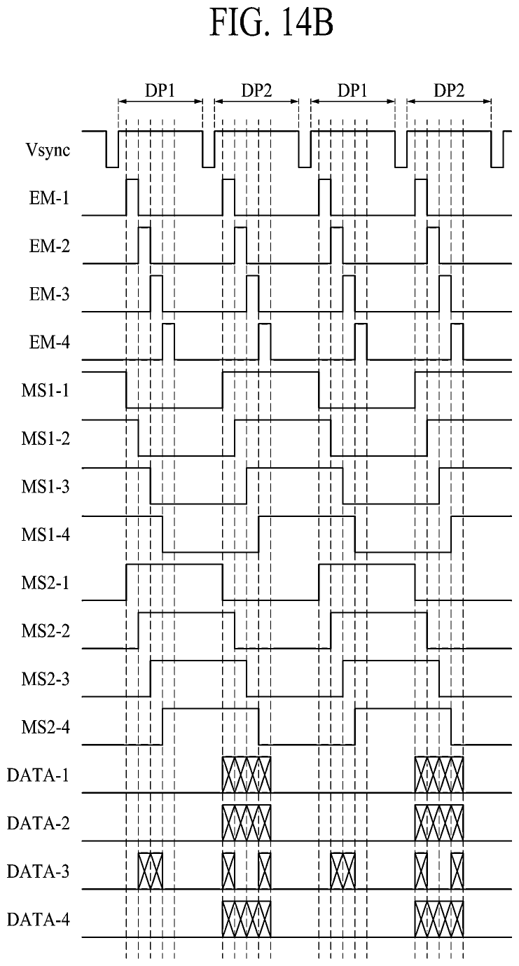

Referring now to FIGS. 14A and 14B, one example of a driving waveform during the first display driving period and the second display driving period will be described in detail below.

FIG. 14A is a diagram illustrating another example of a first mode display area and a second mode display area, and FIG. 14B is a diagram illustrating one example of a driving waveform for the sub-pixels illustrated in FIG. 14A.

In FIGS. 14A and 14B, it is assumed that 16 sub-pixels SPs are disposed in the display area DA for convenience of description. The sub-pixels SPs can be disposed four on each of the four row lines. The display panel 110 can include four first mode selection lines 43-1, 43-2, 43-3, and 43-4 extending in the first direction, four second mode selection lines 44-1, 44-2, 44-3, and 44-4 extending in the first direction, and four data lines 22-1, 22-2, 22-3, and 22-4 extending in the second direction.

Four first mode selection lines 43-1, 43-2, 43-3, and 43-4 are disposed on each of the four row lines, and can supply the first mode selection signals MS1-1, MS1-2, MS1-3, and MS1-4 to the sub-pixels SPs disposed on the row lines. Further, four second mode selection lines 44-1, 44-2, 44-3, and 44-4 are disposed on each of the four row lines and can supply second mode selection signals MS2-1, MS2-2, MS2-3, and MS2-4 to the sub-pixels SP disposed on the row lines.

Meanwhile, four data lines 22-1, 22-2, 22-3, and 22-4 are disposed on each of the four column lines and can supply data voltages to sub-pixels SP disposed on the column lines.

The first mode selection signals MS1-1, MS1-2, MS1-3, and MS1-4 applied through each of the four first mode selection lines 43-1, 43-2, 43-3, and 43-4 can be activated by the gate-on-voltage sequentially supplied during the first display driving period DP1. The first mode selection signal MS1-1 applied through the first mode selection line 43-1 disposed at the uppermost among the first mode selection lines can be activated with the gate-on-voltage, and the gate-on-voltage can be supplied for one frame period. The first control transistor T6 in FIG. 6 can be turned on by the gate-on-voltage of the first mode selection signal MS1-1 in the sub-pixels SP11, SP12, SP13, and SP14 disposed on the first row line, and thus the driving transistor DT in FIG. 6 and the first emitting element ED1 in FIG. 6 of the first mode sub-pixel can be connected. Accordingly, the first emitting element ED1 can be driven by the driving current from the driving transistor DT to emit light. At this time, the second mode selection signal MS2-1 applied through the first second mode selection line 44-1 disposed at the uppermost among the second mode selection lines can be deactivated with the gate-off-voltage, and the gate-off-voltage can be supplied for one frame period. The second mode selection signal MS2-1 applied through the second mode selection line 44-1 can have an opposite phase to the first mode selection signal MS1-1 applied through the first mode selection line 43-1.

Next, the first mode selection signals MS1-2 applied through the first mode selection line 43-2 disposed secondly from the top among the first mode selection lines are shifted by the line width to be activated with by the gate-on-voltage, and the gate-on-voltage can be supplied for one frame period. The first control transistor T6 in FIG. 6 can be turned on by the gate-on-voltage of the first mode selection signals MS1-2 in the sub-pixels SP21, SP22, SP23, and SP24 disposed on the second row line, and thus the driving transistor DT in FIG. 6 and the first emitting element ED1 in FIG. 6 of the first mode sub-pixel can be connected. Accordingly, the first emitting element ED1 can be driven by the driving current from the driving transistor DT to emit light. At this time, the second mode selection signal MS2-2 applied through the second mode selection line 44-2 disposed secondly from the top among the second mode selection lines can be deactivated with the gate-off-voltage, and the gate-off-voltage can be supplied for one frame period. The second mode selection signal MS2-2 applied through the second mode selection line 44-2 can have an opposite phase to the first mode selection signal MS1-2 applied through the first mode selection line 43-2.

Then, the first mode selection signals MS1-3 applied through the first mode selection line 43-3 disposed thirdly from the top among the first mode selection signals are shifted by the line width to be activated with the gate-on-voltage, and the gate-on-voltage can be supplied for one frame period. Then, the first mode selection signal MS1-4 applied through the first mode selection line 43-4 disposed fourthly from the top among the first mode selection signals can be shifted by the line width to be activated with the gate-on-voltage, and the gate-on-voltage can be supplied for one frame period.

The four data lines 22-1, 22-2, 22-3, and 22-4 can supply data voltages to the first mode sub-pixels of the sub-pixels SP disposed on each of the four column lines during the first display driving period DP1. The first data line 22-1 can sequentially supply data voltages to the sub-pixels SP11, SP21, SP31, and SP41 disposed on the first column line. Since the sub-pixels SP11, SP21, SP31, and SP41 disposed on the first column line are all included in the second mode display area DA2, the first data line 22-1 can supply a data voltage corresponding to black data to the sub-pixels SP11, SP21, SP31, and SP41 disposed on the first column line during the first display driving period DP1. That is, the first data line 22-1 can supply a data voltage corresponding to ‘0’ to the sub-pixels SP11, SP21, SP31, and SP41 disposed on the first column line.

The second data line 22-2 can sequentially supply data voltages to the sub-pixels SP12, SP22, SP32, and SP42 disposed on the second column line. Also, the fourth data line 22-4 can sequentially supply data voltages to the sub-pixels SP14, SP24, SP34, and SP44 disposed on the fourth column line. The sub-pixels SP12, SP22, SP32, and SP42 disposed on the second column line and the sub-pixels SP14, SP24, SP34, and SP44 disposed on the fourth column line are all included in the second mode display area DA2. Accordingly, the second data line 22-2 and the fourth data line 22-4 can supply a data voltage corresponding to black data to the sub-pixels SP12, SP22, SP32, and SP42 disposed on the second column line and the sub-pixels SP14, SP24, SP34, and SP44 disposed on the fourth column line during the first display driving period DP1. That is, the second data line 22-2 and the fourth data line 22-4 can supply a data voltage corresponding to ‘0’ to the sub-pixels SP12, SP22, SP32, and SP42 disposed on the second column line and the sub-pixels SP14, SP24, SP34, and SP44 disposed on the fourth column line.

The third data line 22-3 can sequentially supply data voltages to the sub-pixels SP13, SP23, SP33, SP43 disposed on the third column line. Among the sub-pixels SP13, SP23, SP33, and SP43 disposed on the third column line, some sub-pixels SP23 and SP33 are included in the first mode display area DA1, and the other sub-pixels SP13 and SP43 are included in the second mode display area DA2. Accordingly, the third data line 22-3 can supply data voltages corresponding to pixel values for displaying the first image to the some sub-pixels SP23 and SP33 disposed on the third column line during the first display driving period DP1. Further, the third data line 22-3 can supply a data voltage corresponding to black data to the other sub-pixels SP13 and SP43 disposed on the third column line during the first display driving period DP1. That is, the third data line 22-3 can supply a data voltage corresponding to ‘0’ to the other sub-pixels SP13 and SP43 disposed on the third column line.

After the first display driving period DP1, the display panel 110 can operate in the second display driving period DP2. The second mode selection signals MS2-1, MS2-2, MS2-3, and MS2-4 applied through each of the four second mode selection lines 44-1, 44-2, 44-3, and 44-4 can be activated by being sequentially supplied with the gate-on-voltage during the second display operation period DP2. The second mode selection signal MS2-1 applied through the second mode selection line 44-1 disposed at the uppermost among the second mode selection lines can be activated with the gate-on-voltage, and the gate-on-voltage can be supplied for one frame period. The second control transistor T8 in FIG. 6 can be turned on by the gate-on-voltage of the second mode selection signal MS2-1 in the sub-pixels SP11, SP12, SP13, and SP14 disposed on the first row line, and thus the driving transistor DT in FIG. 6 and the second emitting element ED2 in FIG. 6 of the second mode sub-pixel can be connected. Accordingly, the second emitting element ED2 can be driven by the driving current from the driving transistor DT to emit light. At this time, the first mode selection signal MS1-1 applied through the first mode selection line 43-1 disposed at the uppermost among the first mode selection lines can be deactivated with the gate-off-voltage, and the gate-off-voltage can be supplied for one frame period. The first mode selection signal MS1-1 applied through the first mode selection line 43-1 can have an opposite phase to the second mode selection signal MS2-1 applied through the second mode selection line 44-1.

Next, the second mode selection signal MS2-2 applied through the second mode selection line 44-2 disposed secondly from the top among the second mode selection lines is shifted by the line width to be activated with the gate-on-voltage, and the gate-on-voltage can be supplied for one frame period. The eighth control transistor T8 in FIG. 6 can be turned on by the gate-on-voltage of the second mode selection signal MS2-2 in the sub-pixels SP21, SP22, SP23, and SP24 disposed on the second row line, and thus the driving transistor DT in FIG. 6 and the second emitting element ED2 in FIG. 6 of the second mode sub-pixel can be connected. Accordingly, the second emitting element ED2 can be driven by the driving current from the driving transistor DT to emit light. At this time, the first mode selection signals MS1-2 applied through the first mode selection line 43-2 disposed secondly from the top among the first mode selection lines can be deactivated with the gate-off-voltage, and the gate-off-voltage can be supplied for one frame period. The first mode selection signals MS1-2 applied through the first mode selection line 43-2 can have an opposite phase to the second mode selection signals MS2-2 applied through the second mode selection line 44-2.

Then, the second mode selection signal MS2-3 applied through the second mode selection line 44-3 disposed thirdly from the top among the second mode selection lines is shifted by the line width to be activated with the gate-on-voltage, and the gate-on-voltage can be supplied for one frame period. Then, the second mode selection signal MS2-4 applied through the second mode selection line 44-4 disposed fourthly from the top among the second mode selection lines is shifted by the line width to be activated with the gate-on-voltage, and the gate-on-voltage can be supplied for one frame period.

The four data lines 22-1, 22-2, 22-3, and 22-4 can supply data voltages to the second mode sub-pixels of the sub-pixels SP disposed on each of the four column lines during the second display driving period DP2. The first data line 22-1 can sequentially supply data voltages to the sub-pixels SP11, SP21, SP31, and SP41 disposed on the first column line. Since the sub-pixels SP11, SP21, SP31, and SP41 disposed on the first column line are all included in the second mode display area DA2, the first data line 22-1 can supply data voltages corresponding to pixel values for displaying the second image to the sub-pixels SP11, SP21, SP31, and SP41 disposed on the first column line during the second display driving period DP2.

The second data line 22-2 can sequentially supply data voltages to the sub-pixels SP12, SP22, SP32, and SP42 disposed on the second column line. Also, the fourth data line 22-4 can sequentially supply data voltages to the sub-pixels SP14, SP24, SP34, and SP44 disposed on the fourth column line. The sub-pixels SP12, SP22, SP32, and SP42 disposed on the second column line and the sub-pixels SP14, SP24, SP34, and SP44 disposed on the fourth column line are all included in the second mode display area DA2. Accordingly, the second data line 22-2 and the fourth data line 22-4 can supply data voltages corresponding to pixel values for displaying the second image to the sub-pixels SP12, SP22, SP32, and SP42 disposed on the second column line and the sub-pixels SP14, SP24, SP34, and SP44 disposed on the fourth column line during the second display driving period DP2.

The third data line 22-3 can sequentially supply data voltages to the sub-pixels SP13, SP23, SP33, and SP43 disposed on the third column line. Among the sub-pixels SP13, SP23, SP33, and SP43 disposed on the third column line, some sub-pixels SP23 and SP33 are included in the first mode display area DA1, and the other sub-pixels SP13 and SP43 are included in the second mode display area DA2. Accordingly, the third data line 22-3 can supply a data voltage corresponding to black data to the some sub-pixels SP23 and SP33 disposed on the third column line during the second display driving period DP2. Further, the third data line 22-3 can supply data voltages corresponding to pixel values for displaying the second image to the other sub-pixels SP13 and SP43 disposed on the third column line during the second display driving period DP2.

The display panel 110 according to one example embodiment of the present disclosure can control the first mode display area DA1 and the second mode display area DA2 using data output to the sub-pixels SP during the first display driving period DP1 and the second display driving period DP2. The pixel data for displaying the first image in the first mode display area DA1 can be output during the first display driving period DP1, and black data can be output to the sub-pixels SP disposed in the second mode display area DA2. Accordingly, the display panel 110 according to one example embodiment of the present disclosure can ensure that the first image for the first viewing angle mode is not displayed in the second mode display area DA2, and that the first image is displayed only in the first mode display area DA1.

On the other hand, during the second display driving period DP2, pixel data for displaying the second image in the second mode display area DA2 can be output, and black data can be output to the sub-pixels SP disposed in the first mode display area DAL. Accordingly, the display panel 110 according to one example embodiment of the present disclosure can ensure that the second image for the second viewing angle mode is not displayed in the first mode display area DA1, and that the second image is displayed only in the second mode display area DA2.

As such, in the display panel 110 according to one example embodiment of the present disclosure, the position and range of each of the first mode display area DA1 and the second mode display area DA2 can be freely set using the pixel data output to the sub-pixels SP during the first display driving period DP1 and the second display driving period DP2.

Furthermore, the display panel 110 according to one example embodiment of the present disclosure is capable of controlling the viewing angle on a sub-pixel SP basis, allowing fine control of the viewing angle within the display area DA.

Further, the display panel 110 according to one example embodiment of the present disclosure can utilize the two mode selection signals MS1 and MS2 generated inside the display panel 110 to control the viewing angle mode of the sub-pixels. The display panel 110 according to one example embodiment of the present disclosure can minimize signals input from the outside, and the number of signal lines connected to the outside can be greatly reduced.

The display panel 110 according to one example embodiment of the present disclosure can control the viewing angle mode of each of the sub-pixels SP by using a minimum number of signal lines. Accordingly, the display panel 110 according to one example embodiment of the present disclosure can reduce production energy and reduce generation of greenhouse gases by reducing the number of signal lines, thereby implementing ESG (Environment/Social/Governance).

In one or more aspects of the present disclosure, since the viewing angle mode areas can be controlled using data the position and range of the viewing angle mode areas can be freely set.

Further, in one or more aspects of the present disclosure, the viewing angle can be controlled in sub-pixel units, the viewing angle can be precisely controlled within the display area.

Further, in one or more aspects of the present disclosure, by utilizing two mode selection signals generated inside the display panel to control the viewing angle mode of the sub-pixel, signals input from the outside can be minimized. Accordingly, in one or more aspects of the present disclosure, the number of signal lines connected to the outside can be significantly reduced.

In addition, in one or more aspects of the present disclosure, by reducing the number of signal lines formed within the display panel, production energy and the generation of greenhouse gases can be reduced, thereby implementing ESG (Environment/Social/Governance).

The effects to be obtained from the present disclosure are not limited to those mentioned above, and other effects not mentioned will be apparent to one having ordinary skill in the art to which the present disclosure belongs from the following description.

Embodiments of the present disclosure have been described in more detail with reference to the accompanying drawings, but the present disclosure is not necessarily limited to these embodiments and can be practiced in various modifications without departing from the technical ideas of the present disclosure. Accordingly, the embodiments disclosed herein are intended to illustrate and not to limit the technical ideas of the present disclosure, and the scope of the technical ideas of the present disclosure is not limited by these embodiments. Therefore, the embodiments described above are exemplary in all respects and should be understood as non-limiting. The scope of protection of this specification shall be construed by the claims, and all technical ideas within the scope of the claims shall be construed to be included within the scope of the claims.

What is claimed is:

1. A display device, comprising:
a display panel provided with a plurality of sub-pixels for displaying images in display driving period,
wherein each of the plurality of sub-pixels comprises:
a first mode sub-pixel having a first viewing angle and comprising a first light emitting element;
a second mode sub-pixel having a second viewing angle and comprising a second light emitting element;
a driving transistor connected to the first light emitting element or the second light emitting element;
a first mode selection line extending in a first direction and providing a first mode selection signal;
a second mode selection line extending in the first direction and providing a second mode selection signal;
a first control transistor for controlling a connection between the first light emitting element and the driving transistor based on the first mode selection signal; and
a second control transistor for controlling a connection between the second light emitting element and the driving transistor based on the second mode selection signal,
wherein the display driving period is for being time-divided into a first display driving period and a second display driving period, and
wherein the first light emitting element is configured to be connected to the driving transistor in the first display driving period, and the second light emitting element is configured to be connected to the driving transistor in the second display driving period.

2. The display device of claim 1, wherein a gate-on-voltage is for being supplied as the first mode selection signal in the first display driving period, and the gate-on-voltage is for being supplied as the second mode selection signal in the second display driving period.

3. The display device of claim 1, wherein each of the first mode selection signal and the second mode selection signal is a signal in which a gate-on-voltage and a gate-off-voltage are for being repeated in sub-frame units.

4. The display device of claim 3, wherein a period of each of the sub-frame units is equal to a period of one frame period or corresponds to 1/n (n is an even number greater than 0) of one frame period.

5. The display device of claim 1, wherein the first mode selection signal and the second mode selection signal have opposite phases to each other.

6. The display device of claim 1, further comprising:
an emitting control line for supplying an emitting signal; and
a switching transistor for controlling connection between the driving transistor and the first control transistor and between the driving transistor and the second control transistor based on the emitting signal.

7. The display device of claim 6, wherein a gate-on-voltage is for being applied as the emitting signal during a first period in each of the first display driving period and the second display driving period.

8. The display device of claim 7,
wherein the gate-on-voltage is for being applied as the first mode selection signal during a second period longer than the first period in the first display driving period, and
wherein the gate-on-voltage is for being applied as the second mode selection signal during a third period longer than the first period in the second display driving period.

9. The display device of claim 1, further comprising:
a data line extending in a second direction, for supplying a data voltage to the first mode sub-pixel in the first display driving period, and for providing a data voltage to the second mode sub-pixel in the second display driving period.

10. The display device of claim 9,
wherein the display panel comprises a display area in which the plurality of sub-pixels are disposed,
wherein the display area comprises a first mode display area for displaying a first image through the first mode sub-pixel and a second mode display area for displaying a second image through the second mode sub-pixel,
wherein the data line is configured to supply a data voltage corresponding to black data to the first mode sub-pixel disposed in the second mode display area in the first display driving period, and a data voltage corresponding to black data to the second mode sub-pixel disposed in the first mode display area in the second display driving period.

11. The display device of claim 1, wherein the first viewing angle and the second viewing angle are different in at least one of a direction and an angular range.

12. The display device of claim 1, further comprising:
a first mode selection driver disposed in a non-display area and for supplying the first mode selection signal to the first mode selection line; and
a second mode selection driver disposed on one side of the first mode selection driver in the non-display area and for supplying the second mode selection signal to the second mode selection line.

13. A display device, comprising:
a display panel provided with a plurality of sub-pixels comprising a first mode sub-pixel and a second mode sub-pixel in a display area; and
a timing controller for outputting a first pixel data for the first mode sub-pixel and a second pixel data for the second mode sub-pixel to the display panel,
wherein the display panel is configured to supply the first pixel data to the first mode sub-pixel in a first display driving period and the second pixel data to the second mode sub-pixel in a second display driving period, and
wherein the first display driving period and the second display driving period are temporally separated.

14. The display device of claim 13,
wherein the display area comprises a first mode display area for displaying a first image through the first mode sub-pixel and a second mode display area for displaying a second image through the second mode sub-pixel,
wherein a value of the first pixel data for the first mode sub-pixel disposed in the second mode display area is for being 0,
wherein a value of the second pixel data for the second mode sub-pixel disposed in the first mode display area is for being 0.

15. The display device of claim 14, wherein the first mode display area and the second mode display area do not overlap each other.

16. The display device of claim 14, wherein the timing controller is configured to receive video data and position information of the first mode display area or the second mode display area from outside, generate the first pixel data and the second pixel data based on the received video data and the received position information of the first mode display area or the second mode display area

17. The display device of claim 13,
wherein the first mode sub-pixel has a first viewing angle and comprises a first emitting element,
wherein the second mode sub-pixel has a second viewing angle and comprises a second emitting element, and
wherein the first viewing angle and the second viewing angle are different in at least one of a direction and an angular range.

18. The display device of claim 17,
wherein the display panel comprises:
a first mode selection line for supplying a first mode selection signal;
a second mode selection line for supplying a second mode selection signal;
a first control transistor that is configured to be turned on or turned off in response to the first mode selection signal and has a source electrode or a drain electrode connected to the first emitting element; and
a second control transistor that is configured to be turned on or turned off in response to the second mode selection signal and has a source electrode or a drain electrode connected to the second emitting element.

19. The display device of claim 18, wherein a gate-on-voltage is for being supplied as the first mode selection signal in the first display driving period, and a gate-on-voltage is for being supplied as the second mode selection signal in the second display driving period.

20. The display device of claim 19, wherein each of the first mode selection signal and the second mode selection signal is a signal in which the gate-on-voltage and a gate-off-voltage are for being repeated in sub-frame units, and
wherein the first mode selection signal and the second mode selection signal have opposite phases to each other.
